(19) United States
(12) Patent Application Publication
(10) Pub. No.: US 2025/0284618 A1
(43) Pub. Date: Sep. 11, 2025

(54) HEALTH AND ERROR MONITORING OF SENSOR FUSION SYSTEMS

(71) Applicant: NVIDIA Corporation, Santa Clara, CA (US)

(72) Inventors: Daniel Per Olof SVENSSON, Gothenburg (SE); Andreas HULTBERG, Karlstad (SE); Abu Sajana RAHMATHULLAH, Savedalen (SE); Sangmin OH, San Jose, CA (US)

(73) Assignee: NVIDIA Corporation, Santa Clara, CA (US)

(21) Appl. No.: 18/599,546

(22) Filed: Mar. 8, 2024

(51) Int. Cl. G06F 11/36; G06F 18/21; G06F 18/25

(52) U.S. Cl. CPC G06F 11/366; G06F 18/217; G06F 18/25

(57) ABSTRACT

In various examples, systems and methods are disclosed relating to health and error monitoring of sensor fusion systems. Systems and methods are disclosed that aggregate results of monitoring and error checking in a sensor fusion system in a single checkpoint. A processor may include one or more circuits. The one or more circuits may receive perception data from one or more first sensors of a machine. The one or more circuits may receive position data from one or more second sensors of the machine. The one or more circuits may generate output data by performing fusion of at least the perception data and the position data. The one or more circuits may evaluate a plurality of criteria according to at least a subset of the perception data, the position data, and the output data. The one or more circuits may output an error signal according to the evaluation.

### BACKGROUND

A sensor fusion system may provide an environmental description of the surroundings of a vehicle or machine with respect to dynamic objects (e.g., pedestrians, vehicles, machines, robots, animals, etc.) and static objects (e.g., barriers, traffic objects, warehouse objects, road boundaries, buildings, hazards, etc.) given input data from multiple sensor modalities—e.g., RADAR, camera, LiDAR, and ultrasonics. In order for the fusion system to be deemed safe, the fusion system may be compared to various functional safety requirements. An example of a functional safety requirement is to avoid reporting a false positive object with high confidence—e.g., not to output a high confidence that an object is present when there is no actual object at the reported location. Moreover, in order to provide a safe and reliable output to another function or component (e.g., consumer or downstream functions or components of an autonomous or semi-autonomous machine), it is important that the fusion system may assess its health and report errors in an accurate and efficient manner. However, conventional approaches for monitoring a sensor fusion system may be prone to high confidence false positive object detections, rendering these systems less suitable for accurate and efficient deployment.

### SUMMARY

Implementations of the present disclosure relate to health and error monitoring of sensor fusion systems for autonomous or semi-autonomous systems and applications. For example, systems and methods are disclosed that aggregate results of monitoring and error checking in a sensor fusion system in a single checkpoint.

In contrast to conventional systems that perform health monitoring and error checking in a discretized manner at various checkpoints in a sensor fusion system, systems and methods in accordance with the present disclosure perform health monitoring and error checking at a central location. As a result, the health and error checker of the current sensor fusion system is able to perform evaluations with a more comprehensive understanding of the system. The systems and methods in accordance with the present disclosure may aggregate results of monitoring and error checking in a sensor fusion system in a single checkpoint to output an error signal based on the aggregated overall state of the system. In this manner, the system may also assess its health and report errors (e.g., if functionally critical errors occur) in an accurate and efficient manner.

At least one aspect relates to a processor. In various implementations, the processor may include, or may be, one or more circuits. In various implementations, the one or more circuits may receive perception data from one or more first sensors of a vehicle. In various implementations, the one or more circuits may receive position data from one or more second sensors of the vehicle. In various implementations, the one or more circuits may generate output data by performing fusion of at least the perception data and the position data. In various implementations, the one or more circuits may evaluate a plurality of criteria according to at least a subset of the perception data, the position data, and the output data. In various implementations, the one or more circuits may output an error signal according to the evaluation.

In various implementations, the one or more circuits may receive the perception data that have been monitored for a first period of time. In various implementations, the one or more circuits may receive the position data that have been monitored for a second period of time that is shorter than the first period of time. In various implementations, the position data may be monitored for a period of time shorter than a period of time for which the perception data is monitored.

In various implementations, the one or more first sensors may include, or may be, at least one of RADAR sensor, light detection and ranging (LiDAR) sensor, ultrasound sensor, stereo camera, wide-view camera, infrared camera, surround camera, long-range camera, or mid-range camera.

In various implementations, the one or more circuits may detect a first object from the perception data. The plurality of criteria corresponding to the perception data may include, or may be, at least one of validity of the perception data, whether data is missing in the perception data, whether the perception data is stale, validity of timestamp, delay of timestamp, position of the first object within a range of a predetermined position, velocity of the first object within a range of a predetermined velocity, acceleration of the first object within a range of a predetermined acceleration, vertical position of the first object with respect to a ground, size of the first object, or class of the first object.

In various implementations, the one or more second sensors may include, or may be, at least one of global navigation satellite systems (GNSS) sensor, or Global Positioning System (GPS) sensor, inertial measurement unit (IMU) sensor, accelerometer, gyroscope, magnetic compass, magnetometer, microphone, speed sensor, vibration sensor, steering sensor, or brake sensor.

In various implementations, the plurality of criteria according to the position data may include, or may be, at least one of validity of data, whether data is missing, whether data is stale, velocity of the vehicle within a range of a predetermined velocity, or acceleration of the vehicle within a range of a predetermined acceleration.

In various implementations, the one or more circuits may detect a second object from the output data. In various implementations, the plurality of criteria according to the output data may include, or may be, at least one of whether a system time increases between fusion cycles, whether a time difference between input modality data is larger than a threshold, whether a prediction time is larger than a threshold, whether a gap between positions of the second object is greater than a threshold, whether a gap between velocities of the second object is greater than a threshold, or whether a gap between accelerations of the second object is greater than a threshold.

In various implementations, in response to the error signal, the one or more circuits may perform at least one of adjusting a confidence level of a result of the fusion, setting validity information of the result of the fusion, degrading one or more functions of a system performing the fusion, or sending one or more health messages to a health server for debugging purposes.

In various implementations, in generating the output data, the one or more circuits may detect, during a plurality of execution cycles, one or more fused objects by performing fusion of at least one or more first objects and one or more second objects, the one or more first objects being detected based at least on the perception data from one or more first sensors of a vehicle, the one or more second objects being detected based at least on data from one or more third sensors of the vehicle. In various implementations, the one or more circuits may determine, during the plurality of execution cycles, that the one or more first objects are invalid. In various implementations, the one or more circuits may determine a first number of cycles during which the one or more first objects are determined as invalid. In various implementations, may in response to determining that the first number of cycles is equal to a first threshold, the one or more circuits determine the one or more fused objects as invalid.

In various implementations, the one or more circuits may determine, during the plurality of execution cycles, that the one or more second objects are invalid. In various implementations, the one or more circuits may determine a second number of cycles during which the one or more second objects are determined as invalid. In various implementations, in response to determining that the second number of cycles is equal to a second threshold, the one or more circuits may determine the one or more fused objects as invalid.

In various implementations, the one or more circuits may determine whether one or more errors occur during the plurality of execution cycles. In various implementations, in response to determining that one or more errors occur during the plurality of execution cycles, the one or more circuits may determine the one or more fused objects as invalid. The one or more errors may relate to at least one of automotive safety or functionality of performing the fusion.

At least one aspect relates to a system. In various implementations, the system may include one or more processing units and one or more memory units. In various implementations, the one or more memory units may store instructions that, when executed by the one or more processing units, cause the one or more processing units to execute operations including receiving perception data from one or more first sensors of a vehicle. In various implementations, the one or more processing units may receive position data from one or more second sensors of the vehicle. In various implementations, the one or more processing units may generate output data by performing fusion of at least the perception data and the position data. In various implementations, the one or more processing units may evaluate a plurality of criteria according to at least a subset of the perception data, the position data, and the output data. In various implementations, the one or more processing units may output an error signal according to the evaluation.

In various implementations, the one or more processing units may receive the perception data that have been monitored for a first period of time. In various implementations, the one or more processing units may receive the position data that have been monitored for a second period of time that is shorter than the first period of time. In various implementations, the position data may be monitored for a period of time shorter than a period of time for which the perception data is monitored.

In various implementations, the one or more processing units may detect a first object from the perception data. In various implementations, the plurality of criteria corresponding to the perception data may include, or may be, at least one of validity of the perception data, whether data is missing in the perception data, whether the perception data is stale, validity of timestamp, delay of timestamp, position of the first object within a range of a predetermined position, velocity of the first object within a range of a predetermined velocity, acceleration of the first object within a range of a predetermined acceleration, vertical position of the first object with respect to a ground, size of the first object, or class of the first object.

In various implementations, the plurality of criteria according to the position data may include, or may be, at least one of validity of data, whether data is missing, whether data is stale, velocity of the vehicle within a range of a predetermined velocity, or acceleration of the vehicle within a range of a predetermined acceleration.

In various implementations, in response to the error signal, the one or more processing units may perform at least one of adjusting a confidence level of a result of the fusion, setting validity information of the result of the fusion, degrading one or more functions of a system performing the fusion, or sending one or more health messages to a health server for debugging purposes.

At least one aspect relates to a method. In various implementations, the method may include receiving perception data from one or more first sensors of a vehicle. In various implementations, the method may include receiving position data from one or more second sensors of the vehicle. In various implementations, the method may include generating output data by performing fusion of at least the perception data and the position data. In various implementations, the method may include evaluating a plurality of criteria according to at least a subset of the perception data, the position data, and the output data. In various implementations, the method may include outputting an error signal according to the evaluation.

In various implementations, the method may include in response to the error signal, performing at least one of: adjusting a confidence level of a result of the fusion, setting validity information of the result of the fusion, degrading one or more functions of a system performing the fusion, or sending one or more health messages to a health server for debugging purposes.

In various implementations, the processors, systems, and/or methods described herein may be implemented by, or may be included in, at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality, augmented reality, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for health and error monitoring of sensor fusion systems are described in detail below with reference to the attached drawing figures, wherein:

FIG. 1A is an illustration of an example autonomous vehicle, in accordance with some implementations of the present disclosure;

FIG. 1B is an example of camera locations and fields of view for the example autonomous vehicle of FIG. 1A, in accordance with some implementations of the present disclosure;

FIG. 1C is a block diagram of an example system architecture for the example autonomous vehicle of FIG. 1A, in accordance with some implementations of the present disclosure;

FIG. 1D is a system diagram for communication between cloud-based server(s) and the example autonomous vehicle of FIG. 1A, in accordance with some implementations of the present disclosure;

FIG. 2 is a block diagram of an example monitoring system of a sensor fusion system, in accordance with some implementations of the present disclosure;

FIGS. 3-4 are flow diagrams of example processes of monitoring a sensor fusion system, in accordance with some implementations of the present disclosure;

FIG. 5 is a block diagram of an example computing device suitable for use in implementing some implementations of the present disclosure; and

FIG. 6 is a block diagram of an example data center suitable for use in implementing some implementations of the present disclosure.

### DETAILED DESCRIPTION

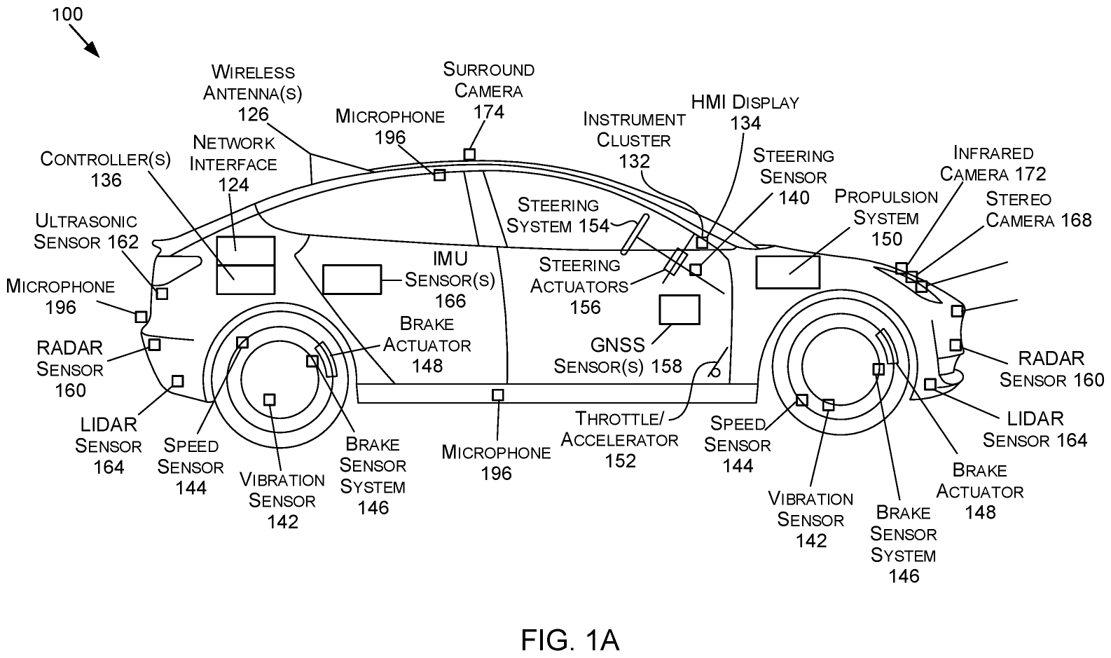

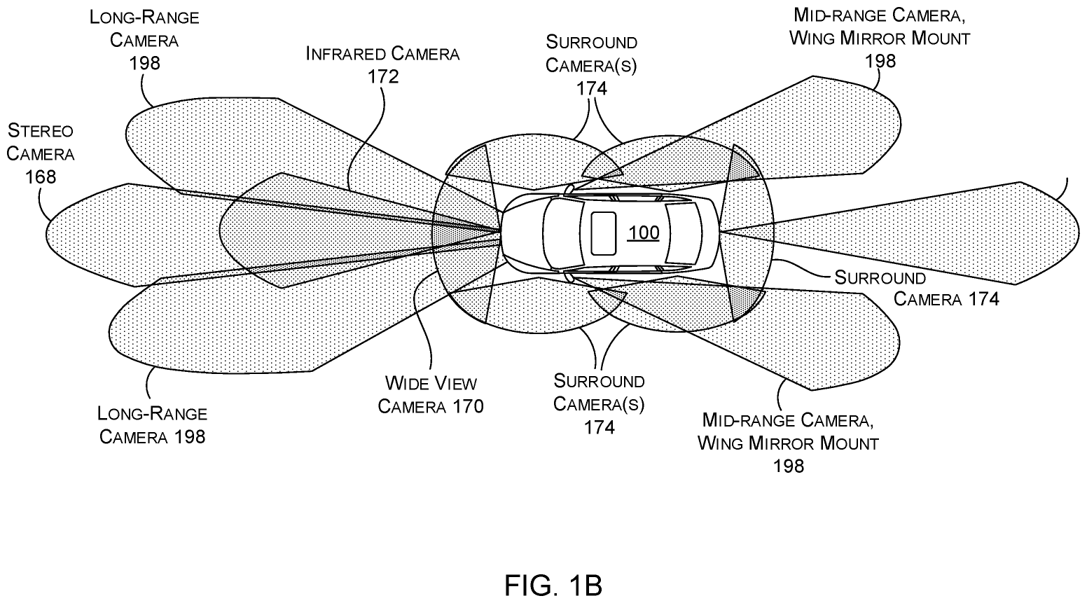

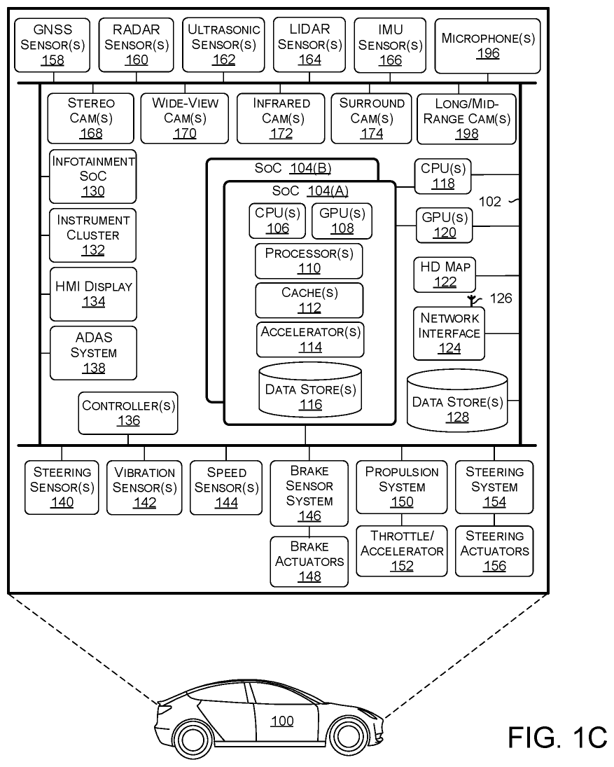

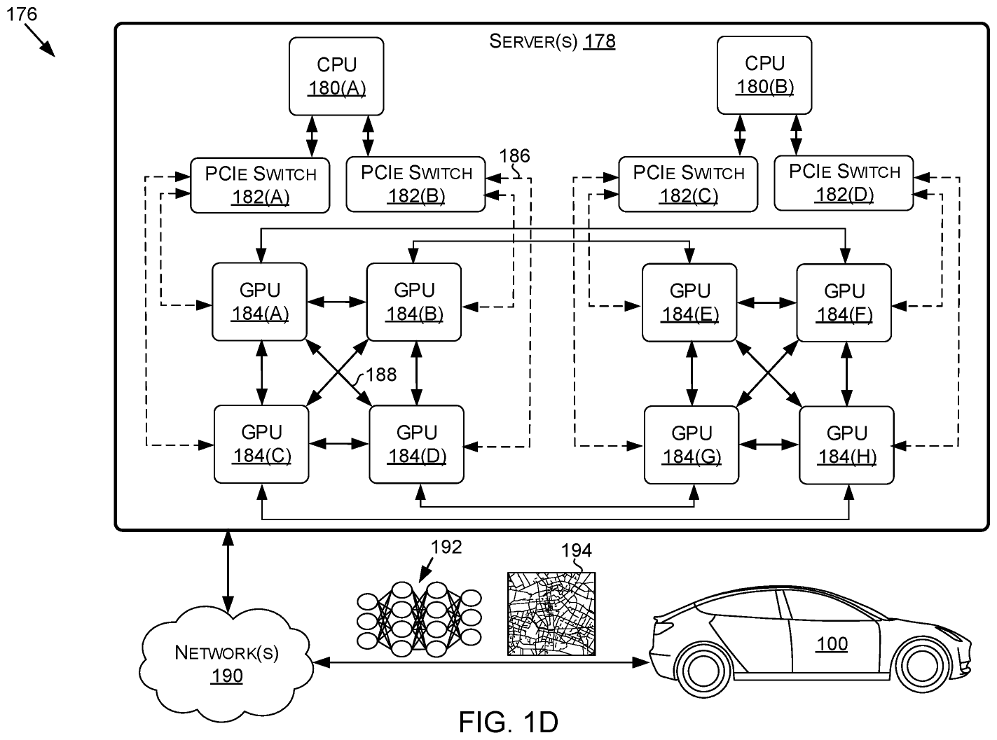

Systems and methods are disclosed related to health and error monitoring of sensor fusion systems in autonomous or semi-autonomous systems and applications. Although the present disclosure may be described with respect to an example autonomous or semi-autonomous vehicle or machine 100 (e.g., “vehicle 100,” “ego-vehicle 100,” “machine 100,” or “ego-machine 100,” an example of which is described with respect to FIGS. 1A-1D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, systems and methods in accordance with the present disclosure may be implemented for monitoring health and error conditions of a multi-sensor fusion system for autonomous or semi-autonomous driving and active safety systems as well as in augmented reality, virtual reality, mixed reality, robotics, security and surveillance, autonomous or semi-autonomous machine applications, and/or any other technology spaces where a multi-sensor fusion system may be used.

This disclosure relates to systems and methods for monitoring health and error conditions of a multi-sensor fusion system, such as for autonomous driving and active safety systems. The fusion system provides an environmental description of the surroundings of a vehicle with respect to dynamic and/or static objects given input data from multiple sensor modalities—e.g., RADAR, camera, LiDAR, and ultrasonics. In order for the fusion system to be deemed safe, the fusion system may be compared against various functional safety requirements. An example of a functional safety requirement is to avoid reporting a false positive object with high confidence—e.g., not to output an object with high confidence when there is no actual object at the reported location. Moreover, in order to provide a safe and reliable output to another function or component (e.g., consumer or downstream functions or components of an autonomous or semi-autonomous system), it is important that the fusion system may assess its health (e.g., presence or absence of functional reliability and/or safety of the system) and report errors if functionally critical errors occur, in an accurate and efficient manner.

To solve these problems, systems and methods in accordance with the present disclosure aggregate results of monitoring and error checking in a sensor fusion system in, or a non-limiting example, a single checkpoint to output an error signal based on the aggregated overall state of the system, rather than spreading out such monitoring and error checking and handling throughout the system. This may allow for a more comprehensive evaluation of candidate errors across the system, which may improve the accuracy of the error detection and allow for more efficient health report generation.

In various implementations, a sensor fusion monitoring system (or “multi-sensor fusion (MSF) monitoring system” or “monitoring system”) may provide a health and safety monitoring technique which may satisfy functional safety requirements (e.g., automotive safety integrity level (ASIL) B requirements). The monitoring system may provide error signals to error-handling systems, which may be used to modify (e.g., limit, turn off, etc.) functionality of the sensor fusion system or any functionalities of the overall system (e.g., a system including an autonomous vehicle, a server, a data center, and so on). For example, an error handling system (or error handling node) may turn off an automatic emergency braking (AEB) function—or modify the execution of the AEB system such as by switching to a different AEB algorithm that does not rely on the particular input experiencing the error-if there are critical sensor fusion errors. The monitoring system may provide health error signals to be used for detailed debugging of safety-critical errors. In some implementations, the health error signals can be a condensed description of health issues. For example, a health error signals can come from a certain health issue being consistent for a few cycles, or can be provided due to multiple health issues being found. In some implementations, if a health error signal (due to a certain health issue) has been sent, the monitoring system can perform a continued error reporting even after the health has recovered, to not have fluctuating error reporting behaviors.

The monitoring system may provide validity information to systems downstream of the sensor fusion system, so that the downstream system may recognize if the output of the sensor fusion is reliable. In some implementations, if a signal indicating invalid outputs/results of a module has been sent, the monitoring system can perform a continued validity reporting even after the module is back at producing reliable results.

In various implementations, a sensor fusion system (e.g., multi-sensor fusion (MSF) system) may include one or more perception systems, one or more ego motion systems, and one or more sensor fusion nodes (e.g., MSF nodes, such as hardware and/or logical components communicably coupled with various other components in a structure of the sensor fusion system), each sensor fusion node including one or more sensor fusion modules (e.g., MSF modules). In various implementations, an autonomous vehicle may include one or more MSF nodes. In various implementations, an MSF node may correspond to one or more autonomous or semi-autonomous vehicles. In various implementations, an MSF node (or an MSF module thereof) may be implemented and/or carried out by hardware, firmware, and/or software in a computing device, a server, or a data center.

In various implementations, each of the one or more perception systems may (1) receive data from at least one sensor (e.g., RADAR sensor, LiDAR sensor, ultrasound sensor, stereo camera, wide-view camera, infrared camera, surround camera, long-range camera, or mid-range camera), (2) detect one or more objects (e.g., obstacles) from the data, and/or (3) output perception data (e.g., detected objects, states or properties of the detected objects) to an MSF node (e.g., a MSF module thereof). In various implementations, each of the one or more ego motion systems may (1) receive data (e.g., raw sensor data) from at least one sensor (e.g., GNSS sensor, or GPS sensor, IMU sensor, accelerometer, gyroscope, magnetic compass, magnetometer, microphone, speed sensor, vibration sensor, steering sensor, or brake sensor), (2) filter the data, (3) aggregate the data (e.g., aggregate raw sensor data from multiple sensors), (4) generate (or extract), from the data, ego motion data, and/or (5) output the ego motion data to an MSF node (e.g., a MSF module thereof). In various implementations, the MSF module (e.g., MSF core module of the MSF module) may receive perception data from the one or more perception systems, receive ego motion data from the one or more ego motion systems, receive node input evaluation data from a node input monitor (which will be described in the following section), perform fusion of at least the perception data and the ego motion data, generate output data (e.g., one or more fused objects and properties of the one or more fused objects), and/or send the output data to other systems or nodes (e.g., systems or nodes that may perform localization, mapping, path planning, decision making, or vehicle control, etc.).

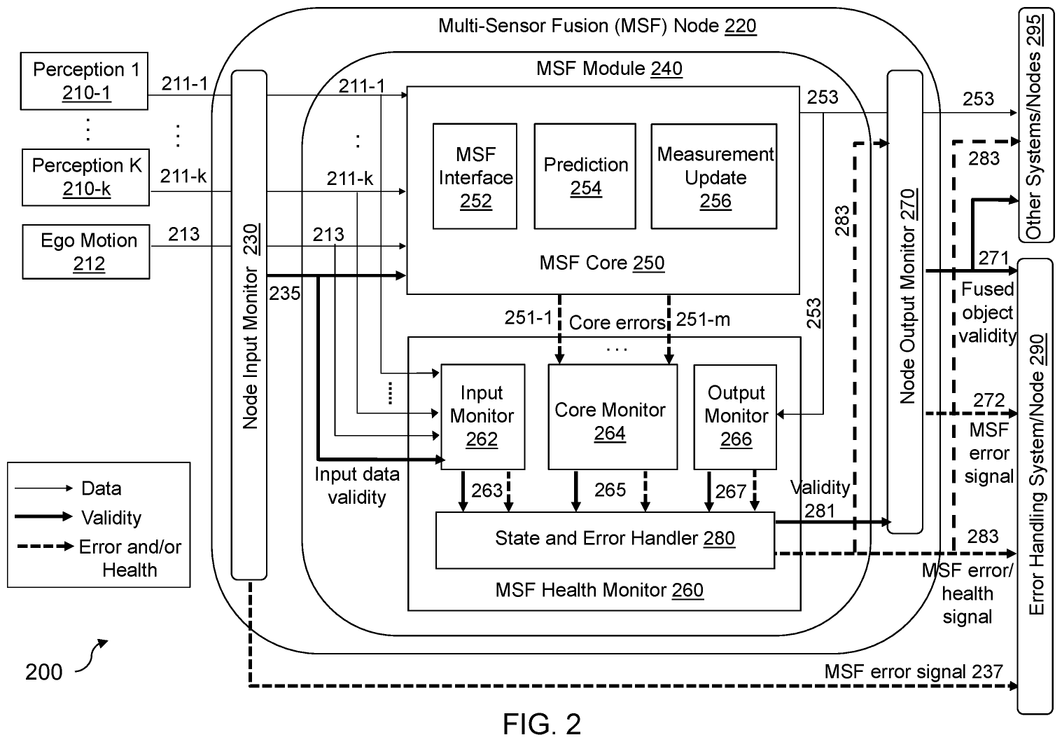

In various implementations, the MSF core module may generate one or more error signals (e.g., signals indicating functional errors of the MSF core module or safety-related errors). In various implementations, the MSF core module may include the submodules of the MSF interface, prediction, and/or measurement update (e.g., as described further herein with respect to FIG. 2). In various implementations, the MSF core module may perform the functions of MSF interface, prediction, and/or measurement update. The MSF interface submodule may receive perception data from the one or more perception systems, receive ego motion data from the one or more ego motion systems, and/or send the output data to other systems or nodes. The prediction submodule may perform prediction of states and/or properties of an object to perform fusion of the object with other objects. The measurement update submodule may update measurements of an object for accurately performing prediction or fusion.

In various implementations, a monitoring system for monitoring an MSF system may include node-level monitors, module-level monitors, and an error handling system (or an error handling node), where the node-level monitors may check higher-level signals and status—e.g., input data validity and/or input data latency—and the module-level monitors may check the internals of the multi-sensor fusion (MSF) processing. In various implementations, based on data output from the monitoring system, the error handling system may control the MSF system or the overall system (e.g., a system including an autonomous vehicle, a server, a data center, and so on) or turn off the MSF system or any functionalities of the overall system. In various implementations, the node-level monitors may include a node input monitor and/or a node output monitor. In various implementations, the module-level monitors may include an MSF health monitor, which includes a module input monitor, an MSF core monitor, a module output monitor, and/or a state and error handler.

In various implementations, the node input monitor may receive perception data from the one or more perception systems, receive ego motion data from the one or more ego motion systems, perform evaluation on the perception data and/or the ego motion data. In various implementations, the node input monitor may generate, based on a result of the evaluation, node input evaluation data (e.g., data indicating validity of the perception data) or one or more error signals (e.g., signals indicating functional errors of MSF core module or safety-related errors). In various implementations, the module input monitor may receive perception data from the one or more perception systems, receive ego motion data from the one or more ego motion systems, receive node input evaluation data from the node input monitor, perform evaluation on the received data, generate, based on a result of the evaluation, module input evaluation data, and send the module input evaluation data (e.g., data indicating validity and/or errors) to the state and error handler. In various implementations, the MSF core monitor may receive one or more error signals from the MSF core module, perform evaluation on the received one or more error signals, generate, based on a result of the evaluation, module core evaluation data, and send the module core evaluation data (e.g., data indicating validity and/or errors) to the state and error handler. In various implementations, the module output monitor may receive the output data generated by the MSF core module, perform evaluation on the received output data, generate, based on a result of the evaluation, module output evaluation data, and send the module output evaluation data (e.g., data indicating validity and/or errors) to the state and error handler. In various implementations, the state and error handler may receive module input evaluation data (from the module input monitor), module core evaluation data (from the MSF core monitor) and/or module output evaluation data (from the module output monitor), perform evaluation on the received evaluation data, and generate, based on a result of the evaluation: (1) validity data (e.g., validity of data relating to the MSF core module) and/or (2) signals indicating errors and/or health of the MSF core module. In various implementations, the node output monitor may receive the output data (e.g., output data from the MSF core module), validity data (e.g., validity data from the state and error handler) and/or an MSF error/health signal (e.g., MSF error/health signal from the state and error handler), perform evaluation on the received data, and generate, based on a result of the evaluation: (1) node output evaluation data (e.g., validity of fused data) and/or (2) signals indicating errors and/or health of the MSF node.

In various implementations, the node input monitor may evaluate or check if an input to the MSF system (e.g., input data from a plurality of sensors, perception data and/or ego motion data) is missing, delayed (e.g., coming with too large latency), stale (e.g., the input information has not been updated for several iterations), or invalid. If any of these events occur, the node input monitor may send one or more error messages to the error handling system. The node input monitor may send information (e.g., node input evaluation data indicating validity of input data) to the MSF core module and/or the MSF input monitor within the MSF health monitor. Using the node input evaluation data, the MSF core module may handle degradations within the MSF system (e.g., invalidity of fusion output, functional degradations of the system, functional or safety-related errors, etc.) based on issues on the input data. For instance, if RADAR perception data is invalid, the MSF core module may allow for longer coasting of camera-only obstacles (, and to adjust how confidences are calculated. The input error events may also lead to the obstacle fusion output being set as invalid-either directly, or after some cycles of consistent errors. For example, if an error occurs on RADAR perception data (e.g., object or obstacle detected by RADAR) more than a predetermined number of execution cycles (e.g., execution cycles of performing fusion and/or sampling data from sensors), the monitoring system (e.g., node output monitor) may set (or determine or detect or evaluate) an MSF output (e.g., fused object or obstacle) as invalid in the node output evaluation data.

In various implementations, the node output monitor may obtain information (e.g., validity data) from the state and error handler about the validity of the MSF system given the current degradation state (e.g., a state of invalidity of fusion output, a state of functional degradations of the system, a state relating to functional or safety-related errors, etc.), and determine the validity of fused objects/obstacles output from the MSF system (e.g., from the MSF core module). In various implementations, the node output monitor may perform the same checks or evaluations as the node input monitor, but for the MSF node. The node output monitor may define expected cycle frequencies and latencies of the MSF node, and/or detect a delayed or stale node (e.g., whether a fusion output of the MSF node is delayed by a threshold amount). The degradation state of MSF may be determined by checking or evaluating input data, output data and/or internal processing of the MSF system (e.g., MSF core module). The node output monitor may use these sources of information to set the validity of the MSF core module to either healthy (or valid or reliable or normal) or unhealthy (or invalid or unreliable or abnormal).

In various implementations, the MSF health monitor may perform more detailed monitoring of dynamic MSF input data or signals, as well as monitoring of internal processing errors (e.g., internal processing errors of the MSF core module) and errors in a reported output of the MSF system (e.g., errors in the fusion output from the MSF core module). The MSF health monitor may communicate error and health signals to a system health service (e.g., a system/node/service for monitoring and evaluating the status and health of an autonomous vehicle, a server, or a data center) directly. The error signal may include a high-level error (e.g., a grouped error combining different types of errors) based on aggregation of individual errors. Additionally, the MSF health monitor may provide a degradation state (e.g., valid or invalid, a state of functional degradations of the MSF system, a state relating to functional errors or safety-related errors) to consumer systems (e.g., systems or nodes that may perform localization, mapping, path planning, decision making, or vehicle control, etc.) by means of metadata (e.g., metadata representing validity of fused object, and/or an error/health state of the MSF system) sent on the fused obstacle output port.

In various implementations, the module input monitor may evaluate or check key properties of the input data (e.g., input data validity), which might not be caught on the producer side (e.g., perception systems or ego motion systems). The module input monitor may determine, based on a result of the evaluation or check (e.g., input data validity), whether or not an output of the MSF system (e.g., fused objects or obstacles) is valid. In Table 1 shown below, examples of evaluations or checks performed by the module input monitor are described. Each evaluation or check may lead to an error/health error signal (e.g., MSF error/health signal generated by the state and error handler), with an identifier (ID) as in the table, being sent to the error handling system or the system health service. In various implementations, those errors may assist debugging of the modules (e.g., MSF core module). In various implementations, each evaluation or check cannot have its own error signal to be sent to an error handler (e.g., the state and error handler or the error handling system or the system health service). In various implementations, the MSF health monitor (e.g., module input monitor, module core monitor, module output monitor) may determine criticality of errors, and based on the criticality, group or aggregate individual errors into an error message per group. The error handling system may then perform functional degradation based on the grouped errors. In various implementations, the MSF core monitor may monitor the internal processing of the sensor fusion system and perform checks, evaluations or analyses that might not be handled by unit testing. In various implementations, to provide a safe and robust fusion system, the MSF core monitor may perform a check, evaluation or analysis including a failure mode and effects analysis (FMEA), within which each step of the processing of an MSF module or system (e.g., MSF core module) is analyzed with respect to potential risks of violating the functional safety requirements. Based on an output or result of the FMEA analysis, potential functional safety risks may be either mitigated by unit testing or core monitor checks. In Table 2 shown below, examples of internal evaluations or checks within a multi-sensor fusion process (e.g., a fusion process performed by an MSF core module) are listed. Each failed check may lead to an error/health error signal (e.g., MSF error/health signal generated by the state and error handler) being sent to the error handling system or the system health service. In various implementations, the module output monitor may perform various evaluations or checks on the output (e.g., fused object or obstacle) produced by the sensor fusion system. For example, the module output monitor may perform, for each field in the output data (e.g., characteristics, properties, size, position, velocity, acceleration, etc.), checking whether it is within a specified range.

In various implementations, the state and error handler may determine whether an error occurs in the input of the MSF system, in the core module of the MSF system, or in the output of the MSF system, and generate, based on a result of the determination, an MSF error/health signal to be sent to an error handling system, other systems/nodes, and/or a system health service. The state and error handler may determine if the errors are severe enough to set the entire sensor fusion system (e.g., the entire MSF system) or the entire system (e.g., the entire autonomous vehicle, the entire server, or the entire data center), as invalid.

In various implementations, the monitoring system may perform module degradation based on outputs of the monitoring system. There may be three main outputs of the monitoring system: (1) validity information of the fusion output (e.g., fused object or obstacle); (2) error messages indicating errors in the input of the MSF system, in the core module of the MSF system, or in the output of the MSF system; and/or (3) health messages indicating presence or absence of reliable functions and/or safety of the MSF system.

In various implementations, the monitoring system (e.g., error handling system/node, or node output monitor) may set (or provide) the validity information in the fusion output for downstream consumers to inform if the fusion output at the current frame (e.g., the fusion output at the current execution cycle) may be trusted. The monitoring system may send error messages to a system error handling module (e.g., error handling system) for potential function degradation. The monitoring system may send health messages to a health service for debugging purposes.

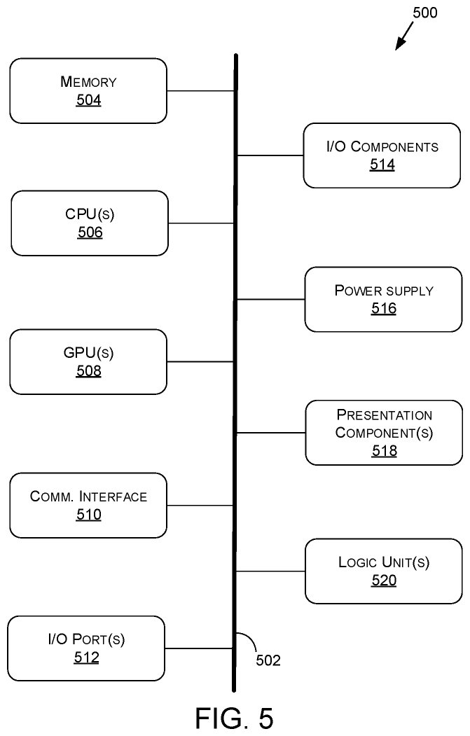

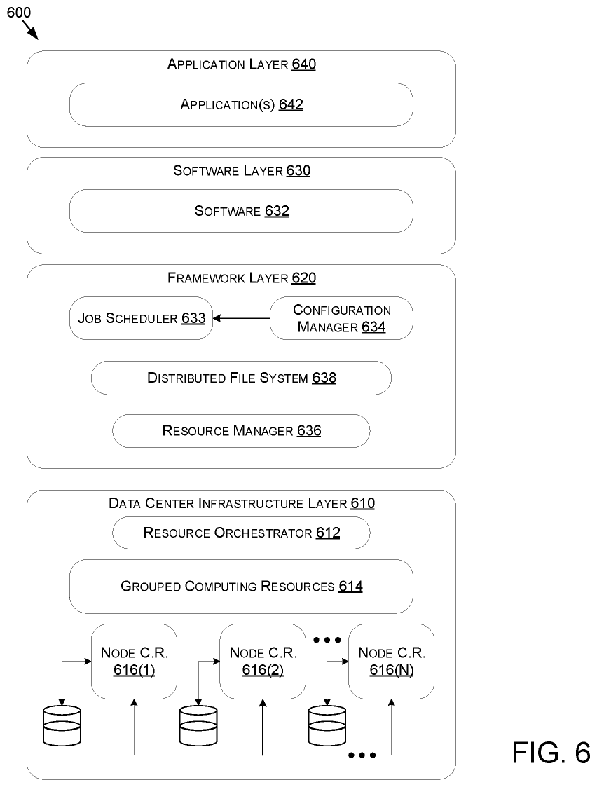

With reference to FIG. 1, FIG. 1 is an example autonomous vehicle is depicted as an illustrative multi-sensor system, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some implementations, the systems, methods, and processes described herein may be executed using similar components, features, and/or functionality to those of example autonomous vehicle 100 of FIGS. 1A-1D, example computing device 500 of FIG. 5, and/or example data center 600 of FIG. 6. Vehicle 100 is an example system that includes multiple sensors of different types, such as vibration sensor 142, RADAR sensor 160, ultrasonic sensor 162, LiDAR sensor 164, stereo camera 168, wide view camera 170, and infrared camera 172. Various other implementations of the disclosed approach are not limited to vehicle systems or these specific types of sensors.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

FIG. 1A is an illustration of an example autonomous vehicle 100, in accordance with some implementations of the present disclosure. The autonomous vehicle 100 (alternatively referred to herein as the “vehicle 100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 100 may be capable of functionality in accordance with one or more of Level 3-Level 5 of the autonomous driving levels. The vehicle 100 may be capable of functionality in accordance with one or more of Level 1-Level 5 of the autonomous driving levels. For example, the vehicle 100 may be capable of driver assistance (Level 1), partial automation (Level 2), conditional automation (Level 3), high automation (Level 4), and/or full automation (Level 5), depending on the implementation. The term “autonomous,” as used herein, may include any and/or all types of autonomy for the vehicle 100 or other machine, such as being fully autonomous, being highly autonomous, being conditionally autonomous, being partially autonomous, providing assistive autonomy, being semi-autonomous, being primarily autonomous, or other designation.

The vehicle 100 may include components such as a chassis, a vehicle body, wheels (e.g., 2, 4, 6, 8, 18, etc.), tires, axles, and other components of a vehicle. The vehicle 100 may include a propulsion system 150, such as an internal combustion engine, hybrid electric power plant, an all-electric engine, and/or another propulsion system type. The propulsion system 150 may be connected to a drive train of the vehicle 100, which may include a transmission, to enable the propulsion of the vehicle 100. The propulsion system 150 may be controlled in response to receiving signals from the throttle/accelerator 152.

A steering system 154, which may include a steering wheel, may be used to steer the vehicle 100 (e.g., along a desired path or route) when the propulsion system 150 is operating (e.g., when the vehicle is in motion). The steering system 154 may receive signals from a steering actuator 156. The steering wheel may be optional for full automation (Level 5) functionality.

The brake sensor system 146 may be used to operate the vehicle brakes in response to receiving signals from the brake actuators 148 and/or brake sensors.

Controller(s) 136, which may include one or more system on chips (SoCs) 104 (FIG. 1C) and/or GPU(s), may provide signals (e.g., representative of commands) to one or more components and/or systems of the vehicle 100. For example, the controller(s) may send signals to operate the vehicle brakes via one or more brake actuators 148, to operate the steering system 154 via one or more steering actuators 156, to operate the propulsion system 150 via one or more throttle/accelerators 152. The controller(s) 136 may include one or more onboard (e.g., integrated) computing devices (e.g., supercomputers) that process sensor signals, and output operation commands (e.g., signals representing commands) to enable autonomous driving and/or to assist a human driver in driving the vehicle 100. The controller(s) 136 may include a first controller 136 for autonomous driving functions, a second controller 136 for functional safety functions, a third controller 136 for artificial intelligence functionality (e.g., computer vision), a fourth controller 136 for infotainment functionality, a fifth controller 136 for redundancy in emergency conditions, and/or other controllers. In some examples, a single controller 136 may handle two or more of the above functionalities, two or more controllers 136 may handle a single functionality, and/or any combination thereof.

The controller(s) 136 may provide the signals for controlling one or more components and/or systems of the vehicle 100 in response to sensor data received from one or more sensors (e.g., sensor inputs). The sensor data may be received from, for example and without limitation, global navigation satellite systems (“GNSS”) sensor(s) 158 (e.g., Global Positioning System sensor(s)), RADAR sensor(s) 160, ultrasonic sensor(s) 162, LiDAR sensor(s) 164, inertial measurement unit (IMU) sensor(s) 166 (e.g., accelerometer(s), gyroscope(s), magnetic compass(es), magnetometer(s), etc.), microphone(s) 196, stereo camera(s) 168, wide-view camera(s) 170 (e.g., fisheye cameras), infrared camera(s) 172, surround camera(s) 174 (e.g., 360 degree cameras), long-range and/or mid-range camera(s) 198, speed sensor(s) 144 (e.g., for measuring the speed of the vehicle 100), vibration sensor(s) 142, steering sensor(s) 140, brake sensor(s) (e.g., as part of the brake sensor system 146), and/or other sensor types.

One or more of the controller(s) 136 may receive inputs (e.g., represented by input data) from an instrument cluster 132 of the vehicle 100 and provide outputs (e.g., represented by output data, display data, etc.) via a human-machine interface (HMI) display 134, an audible annunciator, a loudspeaker, and/or via other components of the vehicle 100. The outputs may include information such as vehicle velocity, speed, time, map data (e.g., the High Definition (“HD”) map 122 of FIG. 1C), location data (e.g., the vehicle's 100 location, such as on a map), direction, location of other vehicles (e.g., an occupancy grid), information about objects and status of objects as perceived by the controller(s) 136, etc. For example, the HMI display 134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 100 further includes a network interface 124 which may use one or more wireless antenna(s) 126 and/or modem(s) to communicate over one or more networks. For example, the network interface 124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 1B is an example of camera locations and fields of view for the example autonomous vehicle 100 of FIG. 1A, in accordance with some implementations of the present disclosure. The cameras and respective fields of view are one example implementation and are not intended to be limiting. For example, additional and/or alternative cameras may be included and/or the cameras may be located at different locations on the vehicle 100.

The camera types for the cameras may include, but are not limited to, digital cameras that may be adapted for use with the components and/or systems of the vehicle 100. The camera(s) may operate at automotive safety integrity level (ASIL) B and/or at another ASIL. The camera types may be capable of any image capture rate, such as 60 frames per second (fps), 120 fps, 240 fps, etc., depending on the implementation. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some implementations, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 100 (e.g., front-facing cameras) may be used for surround view, to help identify forward facing paths and obstacles, as well aid in, with the help of one or more controllers 136 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 170 that may be used to perceive objects coming into view from the periphery (e.g., pedestrians, crossing traffic or bicycles). Although only one wide-view camera is illustrated in FIG. 1B, there may be any number (including zero) of wide-view cameras 170 on the vehicle 100. In addition, any number of long-range camera(s) 198 (e.g., a long-view stereo camera pair) may be used for depth-based object detection, especially for objects for which a neural network has not yet been trained. The long-range camera(s) 198 may also be used for object detection and classification, as well as basic object tracking.

Any number of stereo cameras 168 may also be included in a front-facing configuration. In at least one implementation, one or more of stereo camera(s) 168 may include an integrated control unit comprising a scalable processing unit, which may provide a programmable logic (“FPGA”) and a multi-core micro-processor with an integrated Controller Area Network (“MAY”) or Ethernet interface on a single chip. Such a unit may be used to generate a 3D map of the vehicle's environment, including a distance estimate for all the points in the image. An alternative stereo camera(s) 168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 168 may be used in addition to, or alternatively from, those described herein.

Cameras with a field of view that include portions of the environment to the side of the vehicle 100 (e.g., side-view cameras) may be used for surround view, providing information used to create and update the occupancy grid, as well as to generate side impact collision warnings. For example, surround camera(s) 174 (e.g., four surround cameras 174 as illustrated in FIG. 1B) may be positioned to on the vehicle 100. The surround camera(s) 174 may include wide-view camera(s) 170, fisheye camera(s), 360 degree camera(s), and/or the like. Four example, four fisheye cameras may be positioned on the vehicle's front, rear, and sides. In an alternative arrangement, the vehicle may use three surround camera(s) 174 (e.g., left, right, and rear), and may leverage one or more other camera(s) (e.g., a forward-facing camera) as a fourth surround view camera.

Cameras with a field of view that include portions of the environment to the rear of the vehicle 100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 198, stereo camera(s) 168), infrared camera(s) 172, etc.), as described herein.

FIG. 1C is a block diagram of an example system architecture for the example autonomous vehicle 100 of FIG. 1A, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 100 in FIG. 1C are illustrated as being connected via bus 102. The bus 102 may include a Controller Area Network (MAY) data interface (alternatively referred to herein as a “MAY bus”). A MAY may be a network inside the vehicle 100 used to aid in control of various features and functionality of the vehicle 100, such as actuation of brakes, acceleration, braking, steering, windshield wipers, etc. A MAY bus may be configured to have dozens or even hundreds of nodes, each with its own unique identifier (e.g., a MAY ID). The MAY bus may be read to find steering wheel angle, ground speed, engine revolutions per minute (RPMs), button positions, and/or other vehicle status indicators. The MAY bus may be ASIL B compliant.

Although the bus 102 is described herein as being a MAY bus, this is not intended to be limiting. For example, in addition to, or alternatively from, the MAY bus, FlexRay and/or Ethernet may be used. Additionally, although a single line is used to represent the bus 102, this is not intended to be limiting. For example, there may be any number of busses 102, which may include one or more MAY busses, one or more FlexRay busses, one or more Ethernet busses, and/or one or more other types of busses using a different protocol. In some examples, two or more busses 102 may be used to perform different functions, and/or may be used for redundancy. For example, a first bus 102 may be used for collision avoidance functionality and a second bus 102 may be used for actuation control. In any example, each bus 102 may communicate with any of the components of the vehicle 100, and two or more busses 102 may communicate with the same components. In some examples, each SoC 104, each controller 136, and/or each computer within the vehicle may have access to the same input data (e.g., inputs from sensors of the vehicle 100), and may be connected to a common bus, such the MAY bus.

The vehicle 100 may include one or more controller(s) 136, such as those described herein with respect to FIG. 1A. The controller(s) 136 may be used for a variety of functions. The controller(s) 136 may be coupled to any of the various other components and systems of the vehicle 100, and may be used for control of the vehicle 100, artificial intelligence of the vehicle 100, infotainment for the vehicle 100, and/or the like.

The vehicle 100 may include a system(s) on a chip (SoC) 104. The SoC 104 may include CPU(s) 106, GPU(s) 108, processor(s) 110, cache(s) 112, accelerator(s) 114, data store(s) 116, and/or other components and features not illustrated. The SoC(s) 104 may be used to control the vehicle 100 in a variety of platforms and systems. For example, the SoC(s) 104 may be combined in a system (e.g., the system of the vehicle 100) with an HD map 122 which may obtain map refreshes and/or updates via a network interface 124 from one or more servers (e.g., server(s) 178 of FIG. 1D).

The CPU(s) 106 may include a CPU cluster or CPU complex (alternatively referred to herein as a “CCPLEX”). The CPU(s) 106 may include multiple cores and/or L2 caches. For example, in some implementations, the CPU(s) 106 may include eight cores in a coherent multi-processor configuration. In some implementations, the CPU(s) 106 may include four dual-core clusters where each cluster has a dedicated L2 cache (e.g., a 2 MB L2 cache). The CPU(s) 106 (e.g., the CCPLEX) may be configured to support simultaneous cluster operation enabling any combination of the clusters of the CPU(s) 106 to be active at any given time.

The CPU(s) 106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 108 may include an integrated GPU (alternatively referred to herein as an “iGPU”). The GPU(s) 108 may be programmable and may be efficient for parallel workloads. The GPU(s) 108, in some examples, may use an enhanced tensor instruction set. The GPU(s) 108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some implementations, the GPU(s) 108 may include at least eight streaming microprocessors. The GPU(s) 108 may use compute application programming interface(s) (API(s)). In addition, the GPU(s) 108 may use one or more parallel computing platforms and/or programming models (e.g., NVIDIA's CUDA).

The GPU(s) 108 may be power-optimized for best performance in automotive and embedded use cases. For example, the GPU(s) 108 may be fabricated on a Fin field-effect transistor (FinFET). However, this is not intended to be limiting and the GPU(s) 108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 108 to access the CPU(s) 106 page tables directly. In such examples, when the GPU(s) 108 memory management unit (MMU) experiences a miss, an address translation request may be transmitted to the CPU(s) 106. In response, the CPU(s) 106 may look in its page tables for the virtual-to-physical mapping for the address and transmits the translation back to the GPU(s) 108. As such, unified memory technology may allow a single unified virtual address space for memory of both the CPU(s) 106 and the GPU(s) 108, thereby simplifying the GPU(s) 108 programming and porting of applications to the GPU(s) 108.

In addition, the GPU(s) 108 may include an access counter that may keep track of the frequency of access of the GPU(s) 108 to memory of other processors. The access counter may help ensure that memory pages are moved to the physical memory of the processor that is accessing the pages most frequently.

The SoC(s) 104 may include any number of cache(s) 112, including those described herein. For example, the cache(s) 112 may include an L3 cache that is available to both the CPU(s) 106 and the GPU(s) 108 (e.g., that is connected both the CPU(s) 106 and the GPU(s) 108). The cache(s) 112 may include a write-back cache that may keep track of states of lines, such as by using a cache coherence protocol (e.g., MEI, MESI, MSI, etc.). The L3 cache may include 4 MB or more, depending on the implementation, although smaller cache sizes may be used.

The SoC(s) 104 may include an arithmetic logic unit(s) (ALU(s)) which may be leveraged in performing processing with respect to any of the variety of tasks or operations of the vehicle 100—such as processing DNNs. In addition, the SoC(s) 104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 106 and/or GPU(s) 108.

The SoC(s) 104 may include one or more accelerators 114 (e.g., hardware accelerators, software accelerators, or a combination thereof). For example, the SoC(s) 104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 108 and to off-load some of the tasks of the GPU(s) 108 (e.g., to free up more cycles of the GPU(s) 108 for performing other tasks). As an example, the accelerator(s) 114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 108, and by using an inference accelerator, for example, a designer may target either the DLA(s) or the GPU(s) 108 for any function. For example, the designer may focus processing of CNNs and floating point operations on the DLA(s) and leave other functions to the GPU(s) 108 and/or other accelerator(s) 114.

The accelerator(s) 114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the implementation. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some implementations, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 114 (e.g., the hardware acceleration cluster) may include a computer vision network on-chip and SRAM, for providing a high-bandwidth, low latency SRAM for the accelerator(s) 114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some implementations, one or more tree traversal units (TTUs) may be used for executing one or more ray-tracing related operations.

The accelerator(s) 114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one implementation of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 166 output that correlates with the vehicle 100 orientation, distance, 3D location estimates of the object obtained from the neural network and/or other sensors (e.g., LiDAR sensor(s) 164 or RADAR sensor(s) 160), among others.

The SoC(s) 104 may include data store(s) 116 (e.g., memory). The data store(s) 116 may be on-chip memory of the SoC(s) 104, which may store neural networks to be executed on the GPU and/or the DLA. In some examples, the data store(s) 116 may be large enough in capacity to store multiple instances of neural networks for redundancy and safety. The data store(s) 112 may comprise L2 or L3 cache(s) 112. Reference to the data store(s) 116 may include reference to the memory associated with the PVA, DLA, and/or other accelerator(s) 114, as described herein.

The SoC(s) 104 may include one or more processor(s) 110 (e.g., embedded processors). The processor(s) 110 may include a boot and power management processor that may be a dedicated processor and subsystem to handle boot power and management functions and related security enforcement. The boot and power management processor may be a part of the SoC(s) 104 boot sequence and may provide runtime power management services. The boot power and management processor may provide clock and voltage programming, assistance in system low power state transitions, management of SoC(s) 104 thermals and temperature sensors, and/or management of the SoC(s) 104 power states. Each temperature sensor may be implemented as a ring-oscillator whose output frequency is proportional to temperature, and the SoC(s) 104 may use the ring-oscillators to detect temperatures of the CPU(s) 106, GPU(s) 108, and/or accelerator(s) 114. If temperatures are determined to exceed a threshold, the boot and power management processor may enter a temperature fault routine and put the SoC(s) 104 into a lower power state and/or put the vehicle 100 into a chauffeur to safe stop mode (e.g., bring the vehicle 100 to a safe stop).

The processor(s) 110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 110 may further include a real-time camera engine that may include a dedicated processor subsystem for handling real-time camera management.

The processor(s) 110 may further include a high-dynamic range signal processor that may include an image signal processor that is a hardware engine that is part of the camera processing pipeline.

The processor(s) 110 may include a video image compositor that may be a processing block (e.g., implemented on a microprocessor) that implements video post-processing functions needed by a video playback application to produce the final image for the player window. The video image compositor may perform lens distortion correction on wide-view camera(s) 170, surround camera(s) 174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 108 is not required to continuously render new surfaces. Even when the GPU(s) 108 is powered on and active doing 3D rendering, the video image compositor may be used to offload the GPU(s) 108 to improve performance and responsiveness.

The SoC(s) 104 may further include a mobile industry processor interface (MIPI) camera serial interface for receiving video and input from cameras, a high-speed interface, and/or a video input block that may be used for camera and related pixel input functions. The SoC(s) 104 may further include an input/output controller(s) that may be controlled by software and may be used for receiving I/O signals that are uncommitted to a specific role.

The SoC(s) 104 may further include a broad range of peripheral interfaces to enable communication with peripherals, audio codecs, power management, and/or other devices. The SoC(s) 104 may be used to process data from cameras (e.g., connected over Gigabit Multimedia Serial Link and Ethernet), sensors (e.g., LiDAR sensor(s) 164, RADAR sensor(s) 160, etc. that may be connected over Ethernet), data from bus 102 (e.g., speed of vehicle 100, steering wheel position, etc.), data from GNSS sensor(s) 158 (e.g., connected over Ethernet or MAY bus). The SoC(s) 104 may further include dedicated high-performance mass storage controllers that may include their own DMA engines, and that may be used to free the CPU(s) 106 from routine data management tasks.

The SoC(s) 104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 104 may be faster, more reliable, and even more energy-efficient and space-efficient than conventional systems. For example, the accelerator(s) 114, when combined with the CPU(s) 106, the GPU(s) 108, and the data store(s) 116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 108.

In some examples, a CNN for facial recognition and vehicle owner identification may use data from camera sensors to identify the presence of an authorized driver and/or owner of the vehicle 100. The always on sensor processing engine may be used to unlock the vehicle when the owner approaches the driver door and turn on the lights, and, in security mode, to disable the vehicle when the owner leaves the vehicle. In this way, the SoC(s) 104 provide for security against theft and/or carjacking.

In another example, a CNN for emergency vehicle detection and identification may use data from microphones 196 to detect and identify emergency vehicle sirens. In contrast to conventional systems, that use general classifiers to detect sirens and manually extract features, the SoC(s) 104 use the CNN for classifying environmental and urban sounds, as well as classifying visual data. In a preferred implementation, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 162, until the emergency vehicle(s) passes.

The vehicle may include a CPU(s) 118 (e.g., discrete CPU(s), or dCPU(s)), that may be coupled to the SoC(s) 104 via a high-speed interconnect (e.g., PCIe). The CPU(s) 118 may include an X86 processor, for example. The CPU(s) 118 may be used to perform any of a variety of functions, including arbitrating potentially inconsistent results between ADAS sensors and the SoC(s) 104, and/or monitoring the status and health of the controller(s) 136 and/or infotainment SoC 130, for example.

The vehicle 100 may include a GPU(s) 120 (e.g., discrete GPU(s), or dGPU(s)), that may be coupled to the SoC(s) 104 via a high-speed interconnect (e.g., NVIDIA's NVLINK). The GPU(s) 120 may provide additional artificial intelligence functionality, such as by executing redundant and/or different neural networks, and may be used to train and/or update neural networks based on input (e.g., sensor data) from sensors of the vehicle 100.

The vehicle 100 may further include the network interface 124 which may include one or more wireless antennas 126 (e.g., one or more wireless antennas for different communication protocols, such as a cellular antenna, a Bluetooth antenna, etc.). The network interface 124 may be used to enable wireless connectivity over the Internet with the cloud (e.g., with the server(s) 178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 100 information about vehicles in proximity to the vehicle 100 (e.g., vehicles in front of, on the side of, and/or behind the vehicle 100). This functionality may be part of a cooperative adaptive cruise control functionality of the vehicle 100.

The network interface 124 may include a SoC that provides modulation and demodulation functionality and enables the controller(s) 136 to communicate over wireless networks. The network interface 124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 100 may further include data store(s) 128 which may include off-chip (e.g., off the SoC(s) 104) storage. The data store(s) 128 may include one or more storage elements including RAM, SRAM, DRAM, VRAM, Flash, hard disks, and/or other components and/or devices that may store at least one bit of data.

The vehicle 100 may further include GNSS sensor(s) 158. The GNSS sensor(s) 158 (e.g., GPS, assisted GPS sensors, differential GPS (DGPS) sensors, etc.), to assist in mapping, perception, occupancy grid generation, and/or path planning functions. Any number of GNSS sensor(s) 158 may be used, including, for example and without limitation, a GPS using a USB connector with an Ethernet to Serial (RS-232) bridge.

The vehicle 100 may further include RADAR sensor(s) 160. The RADAR sensor(s) 160 may be used by the vehicle 100 for long-range vehicle detection, even in darkness and/or severe weather conditions. RADAR functional safety levels may be ASIL B. The RADAR sensor(s) 160 may use the MAY and/or the bus 102 (e.g., to transmit data generated by the RADAR sensor(s) 160) for control and to access object tracking data, with access to Ethernet to access raw data in some examples. A wide variety of RADAR sensor types may be used. For example, and without limitation, the RADAR sensor(s) 160 may be suitable for front, rear, and side RADAR use. In some example, Pulse Doppler RADAR sensor(s) are used.

The RADAR sensor(s) 160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed MAY and FlexRay interface. In an example with six antennae, the central four antennae may create a focused beam pattern, designed to record the vehicle's 100 surroundings at higher speeds with minimal interference from traffic in adjacent lanes. The other two antennae may expand the field of view, making it possible to quickly detect vehicles entering or leaving the vehicle's 100 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 100 may further include ultrasonic sensor(s) 162. The ultrasonic sensor(s) 162, which may be positioned at the front, back, and/or the sides of the vehicle 100, may be used for park assist and/or to create and update an occupancy grid. A wide variety of ultrasonic sensor(s) 162 may be used, and different ultrasonic sensor(s) 162 may be used for different ranges of detection (e.g., 2.5 m, 4 m). The ultrasonic sensor(s) 162 may operate at functional safety levels of ASIL B.

The vehicle 100 may include LiDAR sensor(s) 164. The LiDAR sensor(s) 164 may be used for object and pedestrian detection, emergency braking, collision avoidance, and/or other functions. The LiDAR sensor(s) 164 may be functional safety level ASIL B. In some examples, the vehicle 100 may include multiple LiDAR sensors 164 (e.g., two, four, six, etc.) that may use Ethernet (e.g., to provide data to a Gigabit Ethernet switch).

In some examples, the LiDAR sensor(s) 164 may be capable of providing a list of objects and their distances for a 360-degree field of view. Commercially available LiDAR sensor(s) 164 may have an advertised range of approximately 100 m, with an accuracy of 2 cm-3 cm, and with support for a 100 Mbps Ethernet connection, for example. In some examples, one or more non-protruding LiDAR sensors 164 may be used. In such examples, the LiDAR sensor(s) 164 may be implemented as a small device that may be embedded into the front, rear, sides, and/or corners of the vehicle 100. The LiDAR sensor(s) 164, in such examples, may provide up to a 120-degree horizontal and 35-degree vertical field-of-view, with a 200 m range even for low-reflectivity objects. Front-mounted LiDAR sensor(s) 164 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 100. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 164 may be less susceptible to motion blur, vibration, and/or shock.

The vehicle may further include IMU sensor(s) 166. The IMU sensor(s) 166 may be located at a center of the rear axle of the vehicle 100, in some examples. The IMU sensor(s) 166 may include, for example and without limitation, an accelerometer(s), a magnetometer(s), a gyroscope(s), a magnetic compass(es), and/or other sensor types. In some examples, such as in six-axis applications, the IMU sensor(s) 166 may include accelerometers and gyroscopes, while in nine-axis applications, the IMU sensor(s) 166 may include accelerometers, gyroscopes, and magnetometers.

In some implementations, the IMU sensor(s) 166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 166 may enable the vehicle 100 to estimate heading without requiring input from a magnetic sensor by directly observing and correlating the changes in velocity from GPS to the IMU sensor(s) 166. In some examples, the IMU sensor(s) 166 and the GNSS sensor(s) 158 may be combined in a single integrated unit.

The vehicle may include microphone(s) 196 placed in and/or around the vehicle 100. The microphone(s) 196 may be used for emergency vehicle detection and identification, among other things.

The vehicle may further include any number of camera types, including stereo camera(s) 168, wide-view camera(s) 170, infrared camera(s) 172, surround camera(s) 174, long-range and/or mid-range camera(s) 198, and/or other camera types. The cameras may be used to capture image data around an entire periphery of the vehicle 100. The types of cameras used depends on the implementations and requirements for the vehicle 100, and any combination of camera types may be used to provide the necessary coverage around the vehicle 100. In addition, the number of cameras may differ depending on the implementation. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 1A and FIG. 1B.

The vehicle 100 may further include vibration sensor(s) 142. The vibration sensor(s) 142 may measure vibrations of components of the vehicle, such as the axle(s). For example, changes in vibrations may indicate a change in road surfaces. In another example, when two or more vibration sensors 142 are used, the differences between the vibrations may be used to determine friction or slippage of the road surface (e.g., when the difference in vibration is between a power-driven axle and a freely rotating axle).

The vehicle 100 may include an ADAS system 138. The ADAS system 138 may include a SoC, in some examples. The ADAS system 138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 160, LiDAR sensor(s) 164, and/or a camera(s). The ACC systems may include longitudinal ACC and/or lateral ACC. Longitudinal ACC monitors and controls the distance to the vehicle immediately ahead of the vehicle 100 and automatically adjust the vehicle speed to maintain a safe distance from vehicles ahead. Lateral ACC performs distance keeping, and advises the vehicle 100 to change lanes when necessary. Lateral ACC is related to other ADAS applications such as LCA and CWS.

CACC uses information from other vehicles that may be received via the network interface 124 and/or the wireless antenna(s) 126 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 100), while the I2V communication concept provides information about traffic further ahead. CACC systems may include either or both I2V and V2V information sources. Given the information of the vehicles ahead of the vehicle 100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 100 if the vehicle 100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 100 is backing up. Some RCTW systems include AEB to ensure that the vehicle brakes are applied to avoid a crash. RCTW systems may use one or more rear-facing RADAR sensor(s) 160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 100, the vehicle 100 itself must, in the case of conflicting results, decide whether to heed the result from a primary computer or a secondary computer (e.g., a first controller 136 or a second controller 136). For example, in some implementations, the ADAS system 138 may be a backup and/or secondary computer for providing perception information to a backup computer rationality module. The backup computer rationality monitor may run a redundant diverse software on hardware components to detect faults in perception and dynamic driving tasks. Outputs from the ADAS system 138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In implementations that include a neural network(s) running on the supervisory MCU, the supervisory MCU may include at least one of a DLA or GPU suitable for running the neural network(s) with associated memory. In preferred implementations, the supervisory MCU may comprise and/or be included as a component of the SoC(s) 104.

In other examples, ADAS system 138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 138 may be fed into the primary computer's perception block and/or the primary computer's dynamic driving task block. For example, if the ADAS system 138 indicates a forward crash warning due to an object immediately ahead, the perception block may use this information when identifying objects. In other examples, the secondary computer may have its own neural network which is trained and thus reduces the risk of false positives, as described herein.

The vehicle 100 may further include the infotainment SoC 130 (e.g., an in-vehicle infotainment system (IVI)). Although illustrated and described as a SoC, the infotainment system may not be a SoC, and may include two or more discrete components. The infotainment SoC 130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 100. For example, the infotainment SoC 130 may radios, disk players, navigation systems, video players, USB and Bluetooth connectivity, carputers, in-car entertainment, Wi-Fi, steering wheel audio controls, hands free voice control, a heads-up display (HUD), an HMI display 134, a telematics device, a control panel (e.g., for controlling and/or interacting with various components, features, and/or systems), and/or other components. The infotainment SoC 130 may further be used to provide information (e.g., visual and/or audible) to a user(s) of the vehicle, such as information from the ADAS system 138, autonomous driving information such as planned vehicle maneuvers, trajectories, surrounding environment information (e.g., intersection information, vehicle information, road information, etc.), and/or other information.

The infotainment SoC 130 may include GPU functionality. The infotainment SoC 130 may communicate over the bus 102 (e.g., MAY bus, Ethernet, etc.) with other devices, systems, and/or components of the vehicle 100. In some examples, the infotainment SoC 130 may be coupled to a supervisory MCU such that the GPU of the infotainment system may perform some self-driving functions in the event that the primary controller(s) 136 (e.g., the primary and/or backup computers of the vehicle 100) fail. In such an example, the infotainment SoC 130 may put the vehicle 100 into a chauffeur to safe stop mode, as described herein.

The vehicle 100 may further include an instrument cluster 132 (e.g., a digital dash, an electronic instrument cluster, a digital instrument panel, etc.). The instrument cluster 132 may include a controller and/or supercomputer (e.g., a discrete controller or supercomputer). The instrument cluster 132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 130 and the instrument cluster 132. In other words, the instrument cluster 132 may be included as part of the infotainment SoC 130, or vice versa.

FIG. 1D is a system diagram for communication between cloud-based server(s) and the example autonomous vehicle 100 of FIG. 1A, in accordance with some implementations of the present disclosure. The system 176 may include server(s) 178, network(s) 190, and vehicles, including the vehicle 100. The server(s) 178 may include a plurality of GPUs 184(A)-184(H) (collectively referred to herein as GPUs 184), PCIe switches 182(A)-182(H) (collectively referred to herein as PCIe switches 182), and/or CPUs 180(A)-180(B) (collectively referred to herein as CPUs 180). The GPUs 184, the CPUs 180, and the PCIe switches may be interconnected with high-speed interconnects such as, for example and without limitation, NVLink interfaces 188 developed by NVIDIA and/or PCIe connections 186. In some examples, the GPUs 184 are connected via NVLink and/or NVSwitch SoC and the GPUs 184 and the PCIe switches 182 are connected via PCIe interconnects. Although eight GPUs 184, two CPUs 180, and two PCIe switches are illustrated, this is not intended to be limiting. Depending on the implementation, each of the server(s) 178 may include any number of GPUs 184, CPUs 180, and/or PCIe switches. For example, the server(s) 178 may each include eight, sixteen, thirty-two, and/or more GPUs 184.

The server(s) 178 may receive, over the network(s) 190 and from the vehicles, image data representative of images showing unexpected or changed road conditions, such as recently commenced road-work. The server(s) 178 may transmit, over the network(s) 190 and to the vehicles, neural networks 192, updated neural networks 192, and/or map information 194, including information regarding traffic and road conditions. The updates to the map information 194 may include updates for the HD map 122, such as information regarding construction sites, potholes, detours, flooding, and/or other obstructions. In some examples, the neural networks 192, the updated neural networks 192, and/or the map information 194 may have resulted from new training and/or experiences represented in data received from any number of vehicles in the environment, and/or based on training performed at a datacenter (e.g., using the server(s) 178 and/or other servers).

The server(s) 178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 190, and/or the machine learning models may be used by the server(s) 178 to remotely monitor the vehicles.

In some examples, the server(s) 178 may receive data from the vehicles and apply the data to up-to-date real-time neural networks for real-time intelligent inferencing. The server(s) 178 may include deep-learning supercomputers and/or dedicated AI computers powered by GPU(s) 184, such as a DGX and DGX Station machines developed by NVIDIA. However, in some examples, the server(s) 178 may include deep learning infrastructure that use only CPU-powered datacenters.

The deep-learning infrastructure of the server(s) 178 may be capable of fast, real-time inferencing, and may use that capability to evaluate and verify the health of the processors, software, and/or associated hardware in the vehicle 100. For example, the deep-learning infrastructure may receive periodic updates from the vehicle 100, such as a sequence of images and/or objects that the vehicle 100 has located in that sequence of images (e.g., via computer vision and/or other machine learning object classification techniques). The deep-learning infrastructure may run its own neural network to identify the objects and compare them with the objects identified by the vehicle 100 and, if the results do not match and the infrastructure concludes that the AI in the vehicle 100 is malfunctioning, the server(s) 178 may transmit a signal to the vehicle 100 instructing a fail-safe computer of the vehicle 100 to assume control, notify the passengers, and complete a safe parking maneuver.

For inferencing, the server(s) 178 may include the GPU(s) 184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

FIG. 2 is a block diagram of an example system of monitoring a sensor fusion system (e.g., sensor fusion monitoring system 200), in accordance with some implementations of the present disclosure. The sensor fusion monitoring system 200 (or “multi-sensor fusion (MSF) monitoring system” or “monitoring system”) may provide a health and safety monitoring technique which may satisfy functional safety requirements (e.g., ASIL B, ASIL D, etc. requirements). The monitoring system 200 may provide error signals to error-handling systems (e.g., error handling system 290), which may be used to turn off functionality of the sensor fusion system (e.g., MSF system) or any functionalities of the overall system (e.g., a system including an autonomous vehicle 100, a server 178, a data center 600, and so on). For example, the error handling system 290 may turn off an automatic emergency braking (AEB) function if there are critical sensor fusion errors. The monitoring system 200 may provide health error signals (e.g., MSF error/health signal 283) to be used for detailed debugging of safety-critical errors. The monitoring system 200 may provide validity information to systems downstream of the sensor fusion system (e.g., systems or nodes that may perform localization, mapping, path planning, decision making, or vehicle control, etc.), so that the downstream system may recognize if the output of the sensor fusion is reliable.

The monitoring system 200, in brief overview, may include or be coupled with any of one or more perception systems 210-1, . . . , 210-k (hereinafter perception systems 210), one or more ego motion systems 212, and one or more sensor fusion nodes (e.g., MSF nodes 220). The MSF nodes 220 may include one or more sensor fusion modules (e.g., MSF modules 240). In various implementations, an autonomous vehicle may include one or more MSF nodes. In various implementations, an MSF node may correspond to one or more autonomous vehicles. In various implementations, an MSF node 220 (or an MSF module 240 thereof) may be implemented and/or carried out by hardware, firmware, and/or software in a computing device (e.g., computing device 500), a server (e.g., server 178), or a data center (e.g., data center 600).

Referring to FIG. 2, any one or more of the perception systems 210 may (1) include at least one sensor and/or receive data from at least one sensor (e.g., RADAR sensor, LiDAR sensor, ultrasound sensor, stereo camera, wide-view camera, infrared camera, surround camera, long-range camera, or mid-range camera), (2) detect one or more objects (e.g., obstacles) from the data, and/or (3) output perception data (e.g., detected objects, states or properties of the detected objects) to the MSF node 220 (or the MSF module 240 thereof). In various implementations, each of the one or more ego motion systems 212 may (1) include at least one sensor and/or receive data (e.g., raw sensor data) from at least one sensor (e.g., GNSS sensor, or GPS sensor, IMU sensor, accelerometer, gyroscope, magnetic compass, magnetometer, microphone, speed sensor, vibration sensor, steering sensor, or brake sensor), (2) filter the data, (3) aggregate the data (e.g., aggregate raw sensor data from multiple sensors), (4) generate (or extract), from the data, ego motion data, and/or (5) output the ego motion data to the MSF node 220 (e.g., the MSF module 240 thereof).

The MSF module 240 (e.g., MSF core module 250 of the MSF module 240) may receive perception data 211-1, . . . , 211-k (hereinafter perception data 211) from the corresponding perception systems 210, may receive ego motion data 213 from the corresponding motion system 212, and/or may receive node input evaluation data 235 from a node input monitor 230 (which will be described in the following section). The MSF module 240 may perform fusion of the perception data and the ego motion data to generate output data 253 (e.g., representation(s) one or more fused objects and properties of the one or more fused objects). For example, the MSF module 240 may generate the output data 253 to indicate at least one of (relative or absolute) position, velocity, acceleration, Doppler, color, and/or transparency of one or more detected objects using the perception data and the ego motion data, including but not limited to based on weighting of the perception data and the ego motion data. The MSF module 240 may send the output data 253 to other systems or nodes 295 (e.g., systems or nodes that may perform localization, mapping, path planning, decision making, or vehicle control, etc.).

The MSF core module 250 may generate one or more error signals 251-1, . . . , 251-m (hereinafter error signals 251). The MSF core module 250 may generate the error signals 251 to indicate, for example and without limitation, functional errors of the MSF core module 250 or safety-related errors. As described further herein, the MSF core module 250 may generate the error signals 251 responsive to evaluation of data received from sensors and/or perception systems 210.

The MSF core module 250 may include modules (or submodules) of MSF interface 252, prediction 254, and/or measurement update 256. The MSF interface 252 may receive perception data from the perception systems 210, may receive ego motion data (e.g., position data) from the one or more ego motion systems 212, and/or send the output data 253 to other systems or nodes 295. In some implementations, the MSF interface may both receive data from sensors and schedule the order of input data processing in the fusion module (e.g., MSF module). In some implementations, the MSF interface may include a sub-block (e.g., sub-module) called scheduler (not shown) which performs the scheduling operation. In some implementations, the MSF interface may include a track management sub-block (not shown).

The prediction module 254 may perform prediction of states and/or properties of an object to perform fusion of the object with other objects. The measurement update module 256 may update measurements of an object for accurately performing prediction or fusion.

Referring further to FIG. 2, the monitoring system 200 for monitoring the MSF system may include one or more of node-level monitors 230, 270, module-level monitors 260, and an error handling system 290 (or an error handling node), or various combinations thereof. The node-level monitors 230, 270 may check higher-level signals and status, e.g., input data validity and/or input data latency. For example, signals and status at a node level may have a relatively higher level than signals and status at a module level. On the other hand, the module-level monitors 260 may check lower-level signals and status such as the internals of the multi-sensor fusion (MSF) processing. Based on data output from the monitoring system 200, the error handling system 290 may control the MSF system or the overall system (e.g., a system including an autonomous vehicle 100, a server 178, a data center 600, and so on) or turn off the MSF system or any functionalities of the overall system.

The node-level monitors may include a node input monitor 230 and/or a node output monitor 270. The module-level monitors may include an MSF health monitor 260, which includes a module input monitor 262, an MSF core monitor 264, a module output monitor 266, and/or a state and error handler 280.

The node input monitor 230 may evaluate received input data (e.g., input data received from the systems 210, 212 to be used by the MSF node 220 for sensor fusion operations) to perform error detection and/or health evaluation on the received input data. For example, the node input monitor 230 may receive perception data 211 from the corresponding perception systems 210, may receive ego motion data 213 from the corresponding ego motion system 212, and may perform evaluation on the perception data 211 and/or the ego motion data 212. The node input monitor 230 may generate, based on a result of the evaluation, node input evaluation data 235 (e.g., data indicating validity of the perception data) or one or more error signals 237 (e.g., signals indicating functional errors of MSF core module or safety-related errors).

The module input monitor 262 may evaluate or check key properties of the input data (e.g., perception data 211, ego motion data 213), and may determine, based on a result of the evaluation or check (e.g., input data validity), whether or not an output 253 of the MSF system (e.g., fused objects or obstacles) is valid. The module input monitor 262 may receive perception data 211 from the corresponding perception systems 210, may receive ego motion data 213 from the corresponding ego motion system 212, may receive the node input evaluation data 235 from the node input monitor 230, may perform evaluation on the received data, may generate, based on a result of the evaluation, module input evaluation data 263, and send the module input evaluation data 263 (e.g., data indicating validity and/or errors) to the state and error handler 280.

The MSF core monitor 264 may monitor the internal processing of the sensor fusion system (e.g., internal processing of the MSF core module 250) and may perform checks, evaluations or analyses that might not be handled by unit testing. The MSF core monitor 264 may receive error signals 251 from the MSF core module 250, perform evaluation on the received one or more error signals, may generate, based on a result of the evaluation, module core evaluation data 265, and may send the module core evaluation data 265 (e.g., data indicating validity and/or errors) to the state and error handler 280.

The module output monitor 266 may perform various evaluations or checks on the output 253 (e.g., fused object or obstacle) produced by the sensor fusion system. The module output monitor 266 may receive the output data 253 generated by the MSF core module 250, may perform evaluation on the received output data, may generate, based on a result of the evaluation, module output evaluation data 267, and may send the module output evaluation data 267 (e.g., data indicating validity and/or errors) to the state and error handler 280.

The state and error handler 280 may determine whether an error occurs in the input of the MSF system (e.g., perception data 211, ego motion data 213), in the core module 250 of the MSF system, or in the output 253 of the MSF system. The state and error handler 280 may receive module input evaluation data 263 (from the module input monitor 262), module core evaluation data 265 (from the MSF core monitor 264) and/or module output evaluation data 267 (from the module output monitor 266), may perform evaluation on the received evaluation data 263, 265, 267, and may generate, based on a result of the evaluation: (1) validity data 281 (e.g., validity of data relating to the MSF core module 250) and/or (2) signals 283 indicating errors and/or health of the MSF core module. The node output monitor 270 may receive the output data 253 (e.g., output data 253 from the MSF core module 250), validity data 281 (e.g., validity data 281 from the state and error handler 280) and/or an MSF error/health signal 283 (e.g., MSF error/health signal 283 from the state and error handler 280), may perform evaluation on the received data, and may generate, based on a result of the evaluation: (1) node output evaluation data 271 (e.g., data indicating validity of fused data) and/or (2) signals 272 indicating errors and/or health of the MSF node 220.

Referring further to FIG. 2, the node input monitor 230 may evaluate or check if an input to the MSF system (e.g., input data from a plurality of sensors, perception data 211 and/or ego motion data 213) is missing, delayed (e.g., coming with too large latency), stale (e.g., the input information has not been updated for several iterations), or invalid. If any of these events occur, the node input monitor 230 may send one or more error messages 237 to the error handling system 290. The node input monitor 230 may send information (e.g., node input evaluation data 235 on validity of input data) to MSF core module 250 and/or the MSF input monitor 262 within the MSF health monitor 260. Using the node input evaluation data 235, the MSF core module 250 may handle degradations within the MSF system (e.g., invalidity of fusion output, functional degradations of the system, functional or safety-related errors, etc.) based on issues on the input data (as indicated in the node input evaluation data 235). For instance, if RADAR perception data is invalid, the MSF core module 250 may allow for longer coasting of camera-only obstacles (e.g., allow for greater samples of camera-only data to be detected until a system-level error is detected), and to adjust how confidences are calculated. The input error events may also lead to the obstacle fusion output being set as invalid-either directly, or after some cycles of consistent errors. For example, if an error occurs on RADAR perception data (e.g., object or obstacle detected by RADAR) more than a predetermined number of execution cycles (e.g., execution cycles of performing fusion), the monitoring system (e.g., node output monitor 270) may set (or determine or detect or evaluate) an MSF output (e.g., fused object or obstacle) as invalid in the node output evaluation data 271.

Referring to FIG. 2, the node output monitor 270 may obtain information (e.g., MSF health evaluation data 281) from the state and error handler 280 about the validity of the MSF system given the current degradation state (e.g., a state of invalidity of fusion output, a state of functional degradations of the system, a state relating to functional or safety-related errors, etc.), and determine the validity 271 of fused objects/obstacles output from the MSF system (e.g., from the MSF core module). In various implementations, the node output monitor 270 may perform the same checks or evaluations as the node input monitor 230, but for the MSF node 220. The node output monitor 270 may define expected cycle frequencies and latencies of the MSF node 220, and/or detect a delayed or stale node (e.g., whether a fusion output of the MSF node 220 is delayed or stale). The degradation state of MSF may be determined by checking or evaluating input data, output data and/or internal processing of the MSF system (e.g., MSF core module 250). The node output monitor 270 may use these sources of information to set the validity 271 of the MSF core module to either healthy (or valid or reliable or normal) or unhealthy (or invalid or unreliable or abnormal).

Referring further to FIG. 2, the MSF health monitor 260 may monitor dynamic MSF input data or signals (e.g., perception data 211, ego motion data 213), as well as monitor of internal processing errors (e.g., internal processing errors of the MSF core module 250) and errors in a reported output of the MSF system (e.g., errors in the fusion output 253 from the MSF core module 250). The MSF health monitor 260 may communicate error and health signals 283 to a system health service (not shown) directly. For example, the system health service may be a system/node/service for monitoring and evaluating the status and health of an autonomous vehicle, a server, or a data center. The error and health signals 283 may contain a high-level error (e.g., a grouped error combining different types of errors) based on aggregation of individual errors. Additionally, the MSF health monitor 260 may provide a degradation state (e.g., valid or invalid, a state of functional degradations of the MSF system, a state relating to functional errors or safety-related errors) to consumer systems 295 (e.g., systems or nodes that may perform localization, mapping, path planning, decision making, or vehicle control, etc.) by means of metadata sent on the fused obstacle output port. For example, the validity data 281 may contain metadata representing validity of fused object, and the error and health signals 283 may contain metadata representing an error/health state of the MSF system.

Referring further to FIG. 2, the module input monitor 262 may evaluate or check properties of the input data (e.g., input data validity); in some instances, such properties may not individually be detected as errors or invalid on the producer side (e.g., perception systems 210 or ego motion systems 212). The module input monitor 262 may determine, based on a result of the evaluation or check (e.g., input data validity), whether or not an output 253 of the MSF system (e.g., fused objects or obstacles) is valid. In Table 1 shown below, examples of evaluations or checks performed by the module input monitor 262 are described. Each evaluation or check may lead to an error/health error signal (e.g., MSF error/health signal 283 generated by the state and error handler 280), with ID as in the table, being sent to the error handling system 290 or the system health service (not shown). Those errors as a result of the evaluation or check may assist debugging of the modules (e.g., MSF core module 250). In various implementations, each evaluation or check performed by the module input monitor 262 cannot have its own error signal to be sent to an error handler (e.g., the state and error handler 280 or the error handling system 290 or the system health service). In various implementations, the MSF health monitor 260 (e.g., module input monitor 262, module core monitor 264, module output monitor 266) may determine criticality of errors, and based on the criticality, group or aggregate individual errors into an error message per group. The error handling system 290 may then perform functional degradation based on the grouped errors.

TABLE 1
Examples of Evaluations or Checks Performed by Module Input Monitor

| | Input | Input | Check |
|---|---|---|---|
| ID | module | data | (Evaluation) |
| I-1 | Radar (e.g., Radar | Validity | Check if RADAR data is valid. For |
| | sensor, Radar | | example, check if RADAR data has a |
| | perception | | correct format. |
| | system) | | |
| I-2 | Radar | Timestamp | Check if a timestamp of RADAR data is |
| | | | valid. For example, check if the timestamp |
| | | | is within a range of a predetermined |
| | | | maximum delay (e.g., +/− |
| | | | RADAR_MAX_DELAY ms) of the |
| | | | current fusion execution time |
| | | | (current/system time) |
| I-3 | Radar | ID | Check for multiple occurrences of the same |
| | | | ID. |
| I-4 | Radar | Object state or | Check if a value of state or property of a |
| | | property | RADAR object is within a reasonable |
| | | (position, | range. |
| | | velocity, | |
| | | acceleration, etc.) | |
| I-5 | Camera (e.g., | Validity | Check if camera data is valid. For example, |
| | Camera sensor, | | check if camera data has a correct format. |
| | Camera | | |
| | perception | | |
| | system) | | |
| I-6 | Camera | Timestamp | Check if timestamp is valid. For example, |
| | | | check if the timestamp is within a range of |
| | | | a predetermined maximum delay (e.g., +/− |
| | | | RADAR_MAX_DELAY ms) of the |
| | | | current fusion execution time |
| | | | (current/system time) |
| I-7 | Camera | ID | Check for multiple occurrences of the same |
| | | | ID |
| I-8 | Camera | Object state or | Check if a value of state or property of a |
| | | property | RADAR object is within a reasonable |
| | | (position, | range. |
| | | velocity, | |
| | | acceleration, etc.) | |
| I-9 | Camera | Vertical position | Check if z is close to 0 (indicating mis- |
| | | (z) of an | detection of an object on the ground, such |
| | | object/obstacle | as a painted obstacle on the ground). For |
| | | | example, check if z is within a range of a |
| | | | predetermined distance from the ground. |
| I-10 | Camera | Size and class of | Check if the reported object size is |
| | | an object | reasonable given the reported class. For |
| | | | example, check if an object size is within a |
| | | | range of a predetermined size of the |
| | | | reported class. |
| I-11 | Ego motion | Validity | Check if ego motion data is valid. For |
| | | | example, check if ego motion data has a |
| | | | correct format. |
| I-12 | Ego motion | Ego-motion states | Check if a value of state of an ego motion |
| | | (position, | is within a reasonable range. |
| | | velocity, | |
| | | acceleration, etc.) | |

In various implementations, the evaluations or checks for RADAR or camera as shown in Table 1 may be applied to other perception sensors, for example, LiDAR sensor, ultrasound sensor, stereo camera, wide-view camera, infrared camera, surround camera, long-range camera, or mid-range camera, etc. In various implementations, the evaluations or checks for RADAR or camera as shown in Table 1 may be applied to other ego-motion sensors, for example, GNSS sensor, or GPS sensor, IMU sensor, accelerometer, gyroscope, magnetic compass, magnetometer, microphone, speed sensor, vibration sensor, steering sensor, or brake sensor.

The MSF core monitor 264 may monitor the internal processing of the sensor fusion system (e.g., internal processing of the MSF core module 250) and may perform checks, evaluations or analyses that might not be handled by unit testing. To provide a safe and robust fusion system, the MSF core monitor 250 may perform a check, evaluation or analysis including a failure mode and effects analysis (FMEA), within which each step of the processing of an MSF module or system (e.g., MSF core module 250) is analyzed with respect to potential risks of violating the functional safety requirements. Based on an output or result of the FMEA analysis, potential functional safety risks may be either mitigated by unit testing or core monitor checks. In Table 2 shown below, examples of internal evaluations or checks within a multi-sensor fusion process (e.g., a fusion process performed by the MSF core module 250) are listed. Each failed check may lead to an error/health error signal (e.g., MSF error/health signal 283 generated by the state and error handler 280) being sent to the error handling system 290 or the system health service (not shown).

TABLE 2
Examples of Checks or Evaluations of MSF Core Module

| | Internal | Check |
|---|---|---|
| ID | module | (Evaluation) |
| C-1 | MSF | Check if a system time is increasing between each cycle of multi- |
| | Interface | sensor fusion. For example, check if a time between execution |
| | | cycles of multi-sensor fusion is greater than a threshold time. |
| C-2 | MSF | This module can perform three different types of checks: (1) check |
| | interface | if the input modality data in the current cycle is newer than the data |
| | | used in the previous cycle; (2) check if a time difference between |
| | | input modality data (e.g., images, text, time series, etc.) is too large. |
| | | For example, check if a time (or an average time) between receiving |
| | | one data in the previous cycle and receiving next data in the current |
| | | cycle is too large (e.g., greater than a threshold time); and/or (3) |
| | | check if the time stamp difference between two sensor inputs is not |
| | | too large. For example, check if a time stamp difference between a |
| | | radar input and a camera input is greater than a threshold time. |
| C-3 | Prediction | Check if a prediction time is too large. For example, check if a time |
| | | (or an average time) for predicting properties of an object (e.g., |
| | | position, velocity, acceleration, etc.) is greater than a threshold time. |
| C-4 | Prediction | Check if large state jumps have occurred. For example, check if a |
| | | difference between states of an object (e.g., characteristics, |
| | | properties, position, velocity, acceleration, etc.) in different times is |
| | | greater than a threshold time. |
| C-5 | Measurement | Check if large state jumps have occurred. For example, check if a |
| | update | difference between measurement values of an object (e.g., |
| | | characteristics, properties, position, velocity, acceleration, etc.) in |
| | | different times is greater than a threshold time. |
| C-6 | Measurement | Check if a high-priority unassociated fusion object has a suitable |
| | update | measurement close to the object. For example, check if an object has |
| | | a priority higher than a threshold priority, and in response to the |
| | | object having a priority higher than the threshold priority, check if |
| | | there is a measurement close to the object in time and location. In |
| | | response to determining that there is such measurement available, |
| | | perform a measurement update based on the measurement. |

Referring further to FIG. 2, the module output monitor 266 may perform various evaluations or checks on the output 253 (e.g., fused object or obstacle) produced by the sensor fusion system. For example, the module output monitor 266 may perform, for each field in the output data 253 (e.g., characteristics, properties, size, position, velocity, acceleration, etc.), checking whether it is within a specified range. The state and error handler 280 may determine whether an error occurs in the input of the MSF system (e.g., perception data 211, ego motion data 213), in the core module 250 of the MSF system, or in the output 253 of the MSF system, and may generate, based on a result of the determination, an MSF error/health signal 283 to be sent to the error handling system 290, other systems/nodes 295, and/or a system health service (not shown). The state and error handler 280 may determine if the errors are severe enough to set the entire sensor fusion system (e.g., the entire MSF system) or the entire system (e.g., the entire autonomous vehicle 100, the entire server 178, or the entire data center 600), as invalid.

Referring further to FIG. 2, the monitoring system 200 may perform module degradation based on outputs of the monitoring system (e.g., MSF error signal 237, MSF error/health signal 283, MSF error signal 272, fused object validity 271). There may be three main outputs of the monitoring system: (1) validity information of the fusion output (e.g., fused object or obstacle); (2) error messages indicating errors in the input of the MSF system, in the core module of the MSF system, or in the output of the MSF system; and/or (3) health messages indicating presence or absence of reliable functions and/or safety of the MSF system. The monitoring system 200 (e.g., error handling system/node 290, or node output monitor 270) may set (or provide) the validity information in the fusion output for downstream consumers (e.g., other systems/nodes 295) to inform if the fusion output 253 at the current frame (e.g., the fusion output at the current execution cycle) meets criteria to be trusted. The monitoring system 200 may send error messages (e.g., MSF error signal 237, MSF error/health signal 283, MSF error signal 272) to a system error handling module (e.g., error handling system 290) for potential function degradation. The monitoring system 200 may send health messages (e.g., MSF error/health signal 283) to a health service for debugging purposes.

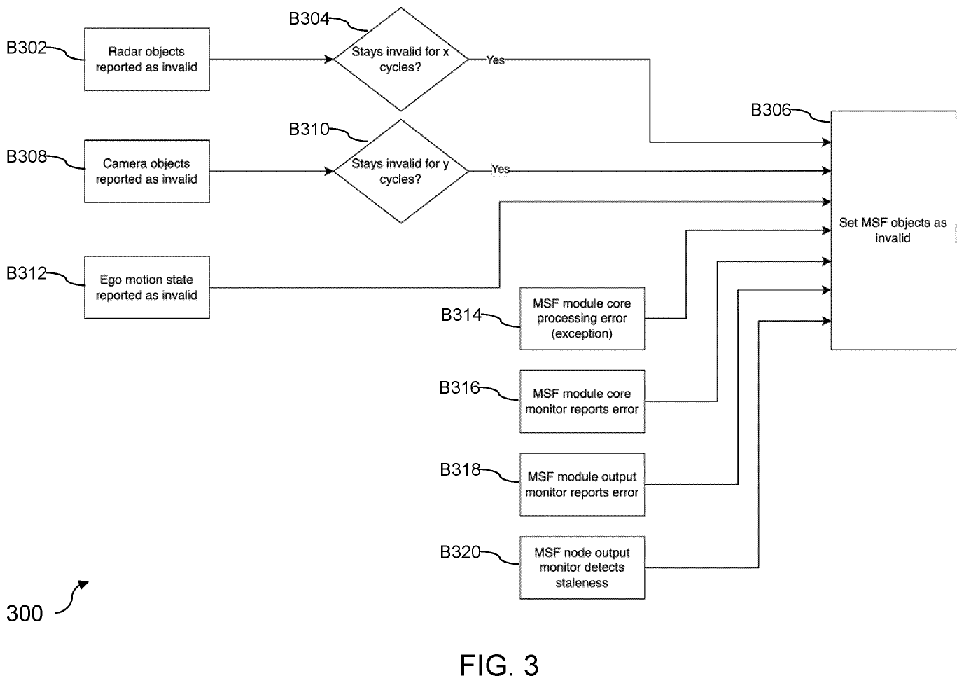

FIG. 3 is a flow diagram of an example process 300 of monitoring a sensor fusion system, in accordance with some implementations of the present disclosure. Each block of process 300, described herein, comprises a computing process that may be performed using any combination of hardware, firmware, and/or software. For instance, various functions may be carried out by a processor executing instructions stored in memory. The process 300 may be embodied as computer-usable instructions stored on computer storage media. The process 300 may be provided by a standalone application, a service or hosted service (standalone or in combination with another hosted service), or a plug-in to another product, to name a few. The process 300 may be executed using similar components, features, and/or functionality to those of example autonomous vehicle 100 of FIGS. 1A-1D, example computing device 500 of FIG. 5, example data center 600 of FIG. 6, and/or example sensor fusion monitoring system 200 of FIG. 2. However, the process 300 may additionally or alternatively be executed by any one system, or any combination of systems, including, but not limited to, those described herein.

In various implementations, a system (e.g., example autonomous vehicle 100, example computing device 500, example data center 600, example sensor fusion monitoring system 200, MSF system) may detect, during a plurality of execution cycles, one or more fused objects by performing fusion of at least one or more first objects and one or more second objects. The one or more first objects may be detected based at least on perception data (e.g., perception data 211-1) from one or more first sensors (e.g., RADAR) of a vehicle and/or position data (e.g., ego motion data 213) from one or more second sensors (e.g., ego-motion sensors) of a vehicle. The one or more second objects may be detected based at least on perception data (e.g., perception data 211-2) from one or more third sensors (e.g., camera) of the vehicle and/or the position data (e.g., ego motion data 213) from the one or more third sensors of the vehicle.

Referring to FIG. 3, in the process 300, at block B302, during the plurality of execution cycles, the system (e.g., perception system 210-1) may detect the one or more first objects based on the perception data (e.g., perception data 211-1) from the one or more first sensors (e.g., RADAR). In various implementations, the system (e.g., node input monitor 230) may determine that the one or more first objects are invalid. In various implementations, the system (e.g., node input monitor 230) may report the one or more first objects as invalid to another module or system (e.g., MSF core module 250, MSF health monitor 260, node output monitor 270, error handling system 290, system 295 outside the MSF node 220).

At block B304, the system (e.g., node input monitor 230, module input monitor 262) may determine a first number of cycles during which the one or more first objects are determined as invalid. In various implementations, in response to determining that the first number of cycles is equal to a first threshold (e.g., determining that the one or more first objects stay invalid for x number of cycles where x is a predetermined positive integer), the system may determine the one or more fused objects as invalid and proceed to block B306.

At block B306, in response to determining that the first number of cycles is equal to the first threshold, the system (e.g., node output monitor 270) may determine the one or more fused objects as invalid, and/or generate a signal (e.g., signal 271) indicating the one or more fused objects as invalid.

At block B308, during the plurality of execution cycles, the system (e.g., perception system 210-2) may detect the one or more second objects based on the data from the one or more third sensors (e.g., camera). In various implementations, the system (e.g., node input monitor 230) may determine that the one or more second objects are invalid. In various implementations, the system (e.g., node input monitor 230) may report the one or more second objects as invalid to another module or system (e.g., MSF health monitor 260, node output monitor 270, system 295 outside the MSF node 220).

At block B310, the system (e.g., node input monitor 230, module input monitor 262) may determine a second number of cycles during which the one or more second objects are determined as invalid. In various implementations, in response to determining that the second number of cycles is equal to a second threshold (e.g., determining that the one or more second objects stay invalid for y number of cycles where y is a predetermined positive integer and y may be different from x), the system may determine the one or more fused objects as invalid and proceed to block B306. At block B306, in response to determining that the second number of cycles is equal to the second threshold, the system (e.g., node output monitor 270) may determine the one or more fused objects as invalid, and/or generate a signal (e.g., signal 271) indicating the one or more fused objects as invalid.

At block B312, during the plurality of execution cycles, the system (e.g., node input monitor 230, module input monitor 262) may determine, based on the data from the one or more second sensors (e.g., ego-motion sensors), that a state of the vehicle (e.g., a motion state of the vehicle) is invalid. In various implementations, the system may report the state as invalid to another module or system (e.g., MSF core module 250, MSF health monitor 260, node output monitor 270, error handling system 290, system 295 outside the MSF node 220). At block B306, in response to reporting the state as invalid, the system may determine the one or more fused objects as invalid, and/or generate a signal (e.g., signal 271) indicating the one or more fused objects as invalid.

In blocks B314 to B320, the system may determine whether one or more errors (e.g., data or object is missing, delayed and/or stale) occur (or are reported) during the plurality of execution cycles. The one or more errors (e.g., MSF error signal 237, MSF error/health signal 283, MSF error signal 272) may relate to at least one of automotive safety or functionality of performing the fusion. At block, B306, in response to determining that one or more errors occur (or are reported) during the plurality of execution cycles, the system (e.g., node output monitor 270) may determine the one or more fused objects as invalid, and/or may generate a signal (e.g., signal 271) indicating the one or more fused objects as invalid.

At block, B314, the system (e.g., MSF core module 250, the core monitor 264) may determine that one or more processing errors from a sensor fusion core module (e.g., error signals 251 from MSF core module 250) occur during the plurality of execution cycles.

At block, B316, the system (e.g., the state and error handler 280) may determine that one or more errors (e.g., one or more errors 265) are reported from a sensor fusion core monitor (e.g., MSF core monitor 264) during the plurality of execution cycles.

At block, B318, the system (e.g., the state and error handler 280) may determine that one or more errors (e.g., one or more errors 267) are reported from a sensor fusion output monitor (e.g., MSF output monitor 266) during the plurality of execution cycles.

At block, B320, the system (e.g., error handling system 290) may determine that one or more errors (e.g., one or more errors 272) relating to staleness (e.g., information on input or object has not been updated for several iterations or cycles) are reported from a node output monitor (e.g., MSF node monitor 270) during the plurality of execution cycles.

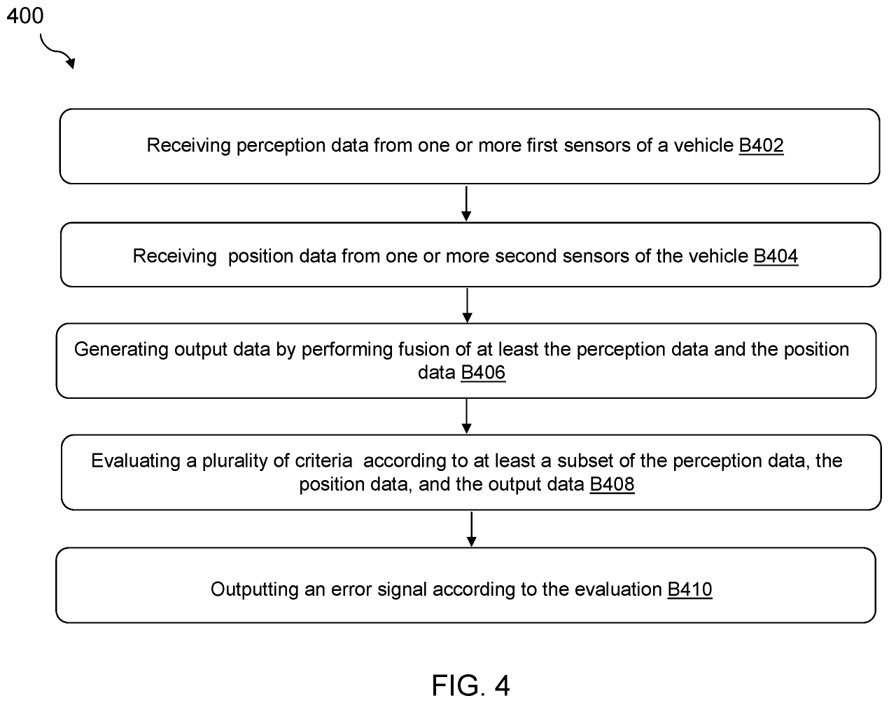

FIG. 4 is a flow diagram of an example process 400 of monitoring a sensor fusion system, in accordance with some implementations of the present disclosure. Each block of process 400, described herein, comprises a computing process that may be performed using any combination of hardware, firmware, and/or software. For instance, various functions may be carried out by a processor executing instructions stored in memory. The process 400 may be embodied as computer-usable instructions stored on computer storage media. The process 400 may be provided by a standalone application, a service or hosted service (standalone or in combination with another hosted service), or a plug-in to another product, to name a few. The process 400 may be executed using similar components, features, and/or functionality to those of example autonomous vehicle 100 of FIGS. 1A-1D, example computing device 500 of FIG. 5, example data center 600 of FIG. 6, and/or example sensor fusion monitoring system 200 of FIG. 2. However, the process 400 may additionally or alternatively be executed by any one system, or any combination of systems, including, but not limited to, those described herein.

Referring to FIG. 4, in the process 400, at block B402, a system (e.g., example autonomous vehicle 100, example computing device 500, example data center 600, example sensor fusion monitoring system 200, example MSF system) may receive perception data (e.g., perception data 211-1) from one or more first sensors (e.g., RADAR) of a vehicle (e.g., autonomous vehicle 100). In various implementations, the one or more first sensors may include, or may be, at least one of RADAR sensor, LiDAR sensor, ultrasound sensor, stereo camera, wide-view camera, infrared camera, surround camera, long-range camera, or mid-range camera. In various implementations, the system (e.g., example MSF system) may detect a first object from the perception data (e.g., perception data 211-1).

At block B404, the system may receive position data (e.g., ego motion data 213) from one or more second sensors (e.g., ego motion sensor) of the vehicle. In various implementations, the one or more second sensors may include, or may be, at least one of GNSS sensor, or GPS sensor, IMU sensor, accelerometer, gyroscope, magnetic compass, magnetometer, microphone, speed sensor, vibration sensor, steering sensor, or brake sensor.

At block B406, the system (e.g., MSF system) may generate output data (e.g., fusion output data 253) by performing fusion of at least the perception data (e.g., perception data 211-1) and the position data (e.g., ego motion data 213). In various implementations, the system may receive the perception data (e.g., RADAR perception data) that have been monitored for a first period of time. In various implementations, system may receive the position data (e.g., ego motion data) that have been monitored for a second period of time that is shorter than the first period of time. In various implementations, the position data may be monitored for a period of time shorter than a period of time for which the perception data is monitored. For example, perception data from an accelerometer may be monitored every second while position data from a RADAR sensor may be monitored every 20 seconds.

At block B408, the system (e.g., node input monitor 230, module input monitor 262, module output monitor 266, state and error handler 280, node output monitor 270) may evaluate a plurality of criteria according to at least a subset of the perception data (e.g., perception data 211), the position data (e.g., ego motion data 213), and the output data (e.g., fusion output data 253). In various implementations, the plurality of criteria corresponding to the perception data may include, or may be, at least one of validity of the perception data, whether data is missing in the perception data, whether the perception data is stale, validity of timestamp, delay of timestamp, position of the first object within a range of a predetermined position, velocity of the first object within a range of a predetermined velocity, acceleration of the first object within a range of a predetermined acceleration, vertical position of the first object with respect to a ground, size of the first object, or class of the first object (see Table 1). In various implementations, the plurality of criteria according to the position data may include, or may be, at least one of validity of data, whether data is missing, whether data is stale, velocity of the vehicle within a range of a predetermined velocity, or acceleration of the vehicle within a range of a predetermined acceleration (see Table 1).

In various implementations, the system (e.g., example MSF system) may detect a second object (e.g., fused object or obstacle) from the output data (e.g., fusion output data 253). In various implementations, the plurality of criteria according to the output data may include, or may be, at least one of whether a system time increases between fusion cycles, whether a time difference between input modality data is larger than a threshold, whether a prediction time is larger than a threshold, whether a gap between positions of the second object is greater than a threshold, whether a gap between velocities of the second object is greater than a threshold, or whether a gap between accelerations of the second object is greater than a threshold (see Table 2).

At block B410, the system (e.g., monitoring system 200) may output an error signal (e.g., MSF error signal 237, MSF error/health signal 283, MSF error signal 272, validity data 271) according to the evaluation. In various implementations, in response to the error signal, the system (e.g., MSF core module 250, error handling system 290) may perform at least one of adjusting a confidence level of a result of the fusion (e.g., increasing or decreasing the confidence level of the fusion output or fused object 253), setting validity information (e.g., validity data 271) of the result of the fusion, degrading one or more functions of a system performing the fusion (e.g., the MSF core module 250 may degrade one or more functions relating to the fusion based on the error message), or sending one or more health messages (e.g., MSF error/health signal 283) to a health server for debugging purposes.

In various implementations, the processors, systems, and/or methods described herein may be implemented by, or may be included in, at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality, augmented reality, or mixed reality content; a system implemented using a robot; a system for performing conversational AI operations; a system for generating synthetic data; a system incorporating one or more virtual machines (VMs); a system implemented at least partially in a data center; a system implementing one or more language models-such as one or more large language models (LLMs); a system for performing generative AI operations; or a system implemented at least partially using cloud computing resources.

### Example Computing Device

FIG. 5 is a block diagram of an example computing device(s) 500 suitable for use in implementing some implementations of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In implementations, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In implementations, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one implementations of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one implementation, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) may correspond to a server having one or more of the above-mentioned computing resources. In addition, in some implementations, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one implementation, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one implementation, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one implementation, resource orchestrator 612 may include a software design infrastructure (SDI) management entity for the data center 600. The resource orchestrator 612 may include hardware, software, or some combination thereof.

In at least one implementation, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one implementation, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one implementation, clustered or grouped computing resources may include grouped computing resource 614 at data center infrastructure layer 610. The resource manager 636 may coordinate with resource orchestrator 612 to manage these mapped or allocated computing resources.

In at least one implementation, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one implementation, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 600. In at least one implementation, trained or deployed machine learning models corresponding to one or more neural networks may be used to infer or predict information using resources described above with respect to the data center 600 by using weight parameters calculated through one or more training techniques, such as but not limited to those described herein.

In at least one implementation, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors, comprising:
one or more circuits to:
receive perception data obtained using one or more first sensors of a machine;
receive position data obtained using one or more second sensors of the machine;
generate output data by, at least in part, performing fusion of at least the perception data and the position data;
evaluate a plurality of criteria according to at least a subset of the perception data, the position data, and the output data; and
output an error signal according to the evaluation.

2. The one or more processors of claim 1, wherein the position data is monitored for a period of time shorter than a period of time for which the perception data is monitored.

3. The one or more processors of claim 1, wherein the one or more first sensors comprise at least one of RADAR sensor, a light detection and ranging (LiDAR) sensor, an ultrasonic sensor, a stereo camera, a wide-view camera, an infrared camera, a surround camera, a long-range camera, or a mid-range camera.

4. The one or more processors of claim 1, wherein:
the one or more circuits are to detect a first object from the perception data; and
the plurality of criteria corresponding to the perception data comprise at least one of validity of the perception data, whether data is missing in the perception data, whether the perception data is stale, validity of a timestamp, delay of a timestamp, position of the first object within a range of a predetermined position, velocity of the first object within a range of a predetermined velocity, acceleration of the first object within a range of a predetermined acceleration, vertical position of the first object with respect to a ground, size of the first object, or class of the first object.

5. The one or more processors of claim 1, wherein the one or more second sensors comprise at least one of global navigation satellite systems (GNSS) sensor, or a Global Positioning System sensor, an inertial measurement unit (IMU) sensor, an accelerometer, a gyroscope, a magnetic compass, a magnetometer, a microphone, a speed sensor, a vibration sensor, a steering sensor, or a brake sensor.

6. The one or more processors of claim 1, wherein the plurality of criteria according to the position data comprises at least one of validity of data, whether data is missing, whether data is stale, velocity of the machine within a range of a predetermined velocity, or acceleration of the machine within a range of a predetermined acceleration.

7. The one or more processors of claim 1, wherein:
the one or more circuits are to detect a first object from the output data; and
the plurality of criteria according to the output data comprise at least one of whether a system time increases between fusion cycles, whether a time difference between input modality data is larger than a threshold, whether a prediction time is larger than a threshold, whether a gap between positions of the first object is greater than a threshold, whether a gap between velocities of the first object is greater than a threshold, or whether a gap between accelerations of the first object is greater than a threshold.

8. The one or more processors of claim 1, wherein in response to the error signal, the one or more circuits are to perform at least one of:
adjusting a confidence level of a result of the fusion;
setting validity information of the result of the fusion;
degrading one or more functions of a system performing the fusion; or
sending one or more health messages to a health server for debugging purposes.

9. The one or more processors of claim 1, wherein the output data is generated, at least in part, by:
detecting, during a plurality of execution cycles, one or more fused objects by performing fusion of at least one or more first objects and one or more second objects, the one or more first objects being detected based at least on the perception data from one or more first sensors of a machine, the one or more second objects being detected based at least on data from one or more third sensors of the machine;
determining, during the plurality of execution cycles, that the one or more first objects are invalid;
determining a first number of cycles during which the one or more first objects are determined as invalid; and
in response to determining that the first number of cycles is equal to a first threshold, determining the one or more fused objects as invalid.

10. The one or more processors of claim 9, wherein the one or more circuits are to:
determine, during the plurality of execution cycles, that the one or more second objects are invalid;
determine a second number of cycles during which the one or more second objects are determined as invalid; and
in response to determining that the second number of cycles is equal to a second threshold, determine the one or more fused objects as invalid.

11. The one or more processors of claim 9, wherein the one or more circuits are to:
determine whether one or more errors occur during the plurality of execution cycles; and
in response to determining that one or more errors occur during the plurality of execution cycles, determine the one or more fused objects as invalid,
wherein the one or more errors relate to at least one of automotive safety or functionality of performing the fusion.

12. The one or more processors of claim 1, wherein the one or more processors is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system for generating or presenting at least one of augmented reality content, virtual reality content, or mixed reality content;
a system for hosting one or more real-time streaming applications;
a system implemented using an edge device;
a system implemented using a robot;
a system for performing one or more conversational AI operations;
a system implementing one or more large language models (LLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

13. A system, comprising:
one or more processors to perform operations comprising:
receiving perception data from one or more first sensors of a machine;
receiving position data from one or more second sensors of the machine;
generating output data by performing fusion of at least the perception data and the position data;
evaluating a plurality of criteria according to at least a subset of the perception data, the position data, and the output data; and
outputting an error signal according to the evaluation.

14. The system of claim 13, wherein the position data is monitored for a period of time shorter than a period of time for which the perception data is monitored.

15. The system of claim 13, wherein:
the operations further comprise detecting a first object from the perception data; and
the plurality of criteria corresponding to the perception data comprise at least one of validity of the perception data, whether data is missing in the perception data, whether the perception data is stale, validity of timestamp, delay of timestamp, position of the first object within a range of a predetermined position, velocity of the first object within a range of a predetermined velocity, acceleration of the first object within a range of a predetermined acceleration, vertical position of the first object with respect to a ground, size of the first object, or class of the first object.

16. The processor of claim 13, wherein the plurality of criteria according to the position data comprises at least one of validity of data, whether data is missing, whether data is stale, velocity of the machine within a range of a predetermined velocity, or acceleration of the machine within a range of a predetermined acceleration.

17. The processor of claim 13, wherein, in response to the error signal, the operations further comprise:
adjusting a confidence level of a result of the fusion;
setting validity information of the result of the fusion;
degrading one or more functions of a system performing the fusion; or
sending one or more health messages to a health server for debugging purposes.

18. The system of claim 13, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system for generating or presenting at least one of augmented reality content, virtual reality content, or mixed reality content;
a system for hosting one or more real-time streaming applications;
a system implemented using an edge device;
a system implemented using a robot;
a system for performing one or more conversational AI operations;
a system implementing one or more large language models (LLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

19. A method comprising:
receiving perception data from one or more first sensors of a machine;
receiving position data from one or more second sensors of the machine;
generating output data by performing fusion of at least the perception data and the position data;
evaluating a plurality of criteria according to at least a subset of the perception data, the position data, and the output data; and
outputting an error signal according to the evaluation.

20. The method of claim 19, further comprising:
in response to the error signal, performing at least one of:
adjusting a confidence level of a result of the fusion;
setting validity information of the result of the fusion;
degrading one or more functions of a system performing the fusion; or
sending one or more health messages to a health server for debugging purposes.
